(19) United States
(12) Patent Application Publication
(10) Pub. No.: US 2025/0122053 A1
(43) Pub. Date: Apr. 17, 2025

(54) CRANE CONTROL METHOD AND CRANE

(71) Applicant: KOBELCO CONSTRUCTION MACHINERY CO., LTD., Hiroshima-shi (JP)

(72) Inventors: Takuya HYONO, Hyogo (JP); Kentaro TERANISHI, Hyogo (JP); Shintaro SASAI, Hyogo (JP)

(73) Assignee: KOBELCO CONSTRUCTION MACHINERY CO., LTD., Hiroshima-shi (JP)

(21) Appl. No.: 18/688,035

(22) PCT Filed: Aug. 31, 2022
(86) PCT No.: PCT/JP2022/032876

§ 371 Date: Feb. 29, 2024

(30) Foreign Application Priority Data
Sep. 2, 2021 (JP) 2021-143324

(51) Int. Cl. B66C 13/48; B66C 13/46; B66C 23/42

(52) U.S. Cl. CPC B66C 13/48; B66C 13/46; B66C 23/42; B66C 2700/0371

(57) ABSTRACT

A prework manipulation or a post-work manipulation for a crane is facilitated. A controller executes a boom raising control in response to a first raising manipulation under a condition that a start mode is set. The controller executes a jib swing out control in response to a second raising manipulation. The boom raising control includes making the controller cause a second winch to wind up a second rope when a detection value from a jib tension force detector falls below a permissible range. The jib swing out control includes making the controller cause the second winch to wind up the second rope.

### TECHNICAL FIELD

The present invention relates to a crane control method that achieves controlling of a crane including a boom and a jib, and relates to a crane.

### BACKGROUND ART

A crane including a boom and a jib has been known (e.g., see Patent Literature 1). The boom is tiltably coupled to a main body part. The jib is rotatably coupled to a distal end of the boom. The hook is connected to a lifting and lowering rope hanging down from a distal end of the jib. Coupling of the boom and the jib to each other is performed on a worksite of the crane.

The crane further includes a jib lock mechanism that locks the jib to the boom in a state where the jib extends along the boom. The boom comes to a lowered state along the ground at completion of the coupling of the boom and the jib to each other.

The jib lock mechanism locks the jib to the boom in a locked state when the boom is in the lowered sate.

The crane further includes a manipulation part that receives a manipulation by an operator. The manipulation part includes a plurality of manipulation levers for each receiving a manipulation for an operation of each of the boom, the jib, and the hook.

The operator gives a prework manipulation for placing the crane in a predetermined reference state to the manipulation part after the completion of the coupling of the boom and the jib to each other.

The prework manipulation includes a manipulation for substantially vertically raising the boom being in the lowered state, a manipulation for unlocking the locked state made by the jib lock mechanism, and a manipulation for causing the jib to swing out from the state of extending along the boom to a predetermined target angle.

The operator gives, to the manipulation part, a manipulation for causing the crane to execute various kinds of works after the prework manipulation.

After the completion of each work by the crane, the operator gives, to the manipulation part, a post-processing manipulation for placing each of the boom and the jib in the lowered state.

The post-processing manipulation includes a manipulation for rotating the jib to a position where the jib is locked to the boom and a manipulation for tilting the boom being in the raised state to lie along the ground.

The boom, the jib, and other component are disassembled after the post-processing manipulation. The post-processing manipulation may be given with an aim of preventing the crane having completed the work from falling over due to, for example, a strong wind.

### CITATION LIST

### Patent Literature

Patent Literature 1: Japanese Unexamined Patent Publication No. 2006-176242

A rope connected to the jib may loosen while the boom is rising under a condition that the jib lock mechanism makes the locked state. The loosening of the rope may result in a failure of winding up of the rope by the winch.

Further, an excessive tension force may be applied to the rope connected to the jib while the boom is tilting downward under the condition that the jib lock mechanism makes the locked state. The application of the excessive tension force to the rope may cause a trouble, such as a damage to the rope.

### SUMMARY OF INVENTION

An object of the present invention is to provide a crane control method which achieves facilitation of a prework manipulation for a crane or a post-work manipulation for the crane, and to provide a crane.

A crane control method according to one aspect of the present invention is a crane control method for controlling a crane including: a main body part; a boom tiltably coupled to the main body part; a first rope connected to the boom; a first winch that changes an angle of the boom to the main body part by winding up the first rope or unwinding out the first rope; a jib rotatably coupled to a distal end of the boom; a second rope connected to the jib; a second winch that changes an angle of the jib to the boom by winding up the second rope or unwinding out the second rope; a jib lock mechanism configured to lock the jib to the boom in a state where the jib extends along the boom and unlock a locked state of the jib to the boom; a lock detector configured to detect the locked state of the jib to the boom that is made by the jib lock mechanism; a hook for supporting a hoisted load; a third rope connected to the hook and hanging down from a distal end of the jib; a third winch that changes a length of a portion of the third rope that hangs down from the distal end of the jib by winding up the third rope or unwinding out the third rope; and a manipulation part that receives a manipulation by a person. The crane control method includes executing: a boom raising control until the angle of the boom reaches within a predetermined target raising range in response to a predetermined first raising manipulation to the manipulation part under a condition that a raising mode which is one of a plurality of predetermined control modes is set and the lock detector detects the locked state; an unlocking control of causing the jib lock mechanism to unlock the locked state after the angle of the boom reaches within the target raising range; and a jib swing out control until the angle of the jib reaches within a target work range in response to a predetermined second raising manipulation to the manipulation part under a condition that the raising mode is set after the execution of the unlocking control. The boom raising control includes: causing the first winch to wind up the first rope; and causing the second winch to wind up the second rope when a tension force of the second rope falls below a permissible range. The jib swing out control includes causing the second winch to wind up the second rope.

A crane control method according to another aspect of the present invention is a crane control method for controlling a crane including: a main body part; a boom tiltably coupled to the main body part; a first rope connected to the boom; a first winch that changes an angle of the boom to the main body part by winding up the first rope or unwinding out the first rope; a jib rotatably coupled to a distal end of the boom; a second rope connected to the jib; a second winch that changes an angle of the jib to the boom by winding up the second rope or unwinding out the second rope; a jib lock mechanism configured to lock the jib to the boom in a state where the jib extends along the boom and unlock a locked state of the jib to the boom; a lock detector configured to detect the locked state of the jib to the boom that is made by the jib lock mechanism; a hook for supporting a hoisted load; a third rope connected to the hook and hanging down from a distal end of the jib; a third winch that changes a length of a portion of the third rope that hangs down from the distal end of the jib by winding up the third rope or unwinding out the third rope; and a manipulation part that receives a manipulation by a person. The crane control method includes executing: a jib closing control until the lock detector detects the locked state in response to a predetermined first lowering manipulation to the manipulation part under a condition that a lowering mode which is one of a plurality of predetermined control modes is set and the angle of the jib is within a predetermined target work range; and a boom tilting control until the angle of the boom reaches within a predetermined target tilting range in response to a predetermined second lowering manipulation to the manipulation part under a condition that the lowering mode is set after the lock detector detects the locked state. The jib closing control includes causing the second winch to unwind out the second rope. The boom tilting control includes: causing the first winch to unwind out the first rope; and causing the second winch to unwind out the second rope when the tension force of the second rope exceeds the permissible range.

A crane according to another aspect of the present invention includes: the boom; the first rope; the first winch; a boom angle detector; the jib; the second rope; the second winch; a jib tension force detector; a jib angle detector; the jib lock mechanism; the lock detector; the hook; the third rope; the third winch; the manipulation part; and a controller. In the crane according to this aspect, the controller executes the crane method according to each aspect described above.

### BRIEF DESCRIPTION OF DRAWINGS

FIG. 1 is a configuration illustration of a crane according to an embodiment of the present invention.

FIG. 2 is a block diagram showing a configuration of control relevant devices in the crane according to the embodiment of the present invention.

FIG. 3 is a block diagram showing a configuration of a controller in the crane according to the embodiment of the present invention.

FIG. 4 is a configuration diagram of a latch device in the crane according to the embodiment of the present invention.

FIG. 5 is a diagram of the latch device making an unlocked state in the crane according to the embodiment of the present invention.

FIG. 6 is an illustration showing a boom lowered state in the crane according to the embodiment of the present invention.

FIG. 7 is an illustration showing a boom raising completion state in the crane according to the embodiment of the present invention.

FIG. 8 is an illustration showing a reference state of the crane according to the embodiment of the present invention.

FIG. 9 is an illustration showing a jib pre-closed or opened state in the crane according to the embodiment of the present invention.

FIG. 10 is an illustration showing a jib closed state in the crane according to the embodiment of the present invention.

FIG. 11 is a flowchart showing an example sequence of a first raising control in the crane according to the embodiment of the present invention.

FIG. 12 is a flowchart showing an example sequence of a boom raising control in the crane according to the embodiment of the present invention.

FIG. 13 is a flowchart showing an example sequence of a second raising control in the crane according to the embodiment of the present invention.

FIG. 14 is a flowchart showing an example sequence of a jib swing out control in the crane according to the embodiment of the present invention.

FIG. 15 is a flowchart showing an example sequence of a first lowering control in the crane according to the embodiment of the present invention.

FIG. 16 is a flowchart showing an example sequence of a jib closing control in the crane according to the embodiment of the present invention.

FIG. 17 is a flowchart showing an example sequence of a second lowering control in the crane according to the embodiment of the present invention.

FIG. 18 is a flowchart showing an example sequence of a boom tilting control in the crane according to the embodiment of the present invention.

FIG. 19 is a flowchart showing an example sequence of a jib closing control in a crane according to a modified embodiment of the present invention.

FIG. 20 is a configuration illustration of a crane according to a modified embodiment of the present invention.

### DESCRIPTION OF EMBODIMENTS

Hereinafter, embodiments of the present invention will be described with reference to the accompanying drawings. It should be noted that each of the following embodiments illustrates one specific example of the present invention, and does not delimit the technical scope of the present invention.

### Configuration of a crane 10

The crane 10 according to an embodiment is a working machine for lifting and transferring a hoisted load. Hereinafter, the crane 10 will be described as an example jib crane.

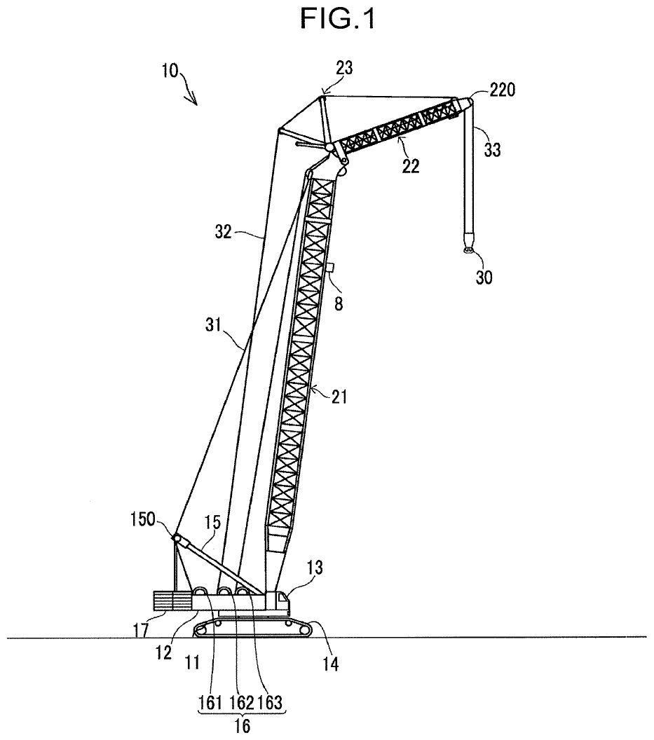

As shown in FIG. 1, the crane 10 includes a lower traveling body 11, an upper slewing body 12, a cab 13, a gantry 15, a winch device 16, a counterweight 17, a boom 21, a gantry sheave 150, a jib 22, a jib point sheave 220, a strut 23, a latch device 8, a hook 30, a first rope 31, a second rope 32, and a third rope 33. The winch device 16 includes a first winch 161, a second winch 162, and a third winch 163.

The upper slewing body 12 is a slewing body swingably supported on the lower traveling body 11. The upper slewing body 12 is integrally formed with the cab 13 and the gantry 15.

The gantry 15 is fixedly attached to the upper slewing body 12 in a state of rising from the upper slewing body 12. The upper slewing body 12 further supports the winch device 16, the counterweight 17, and the boom 21. One of or both the second winch 162 and the third winch 163 may be located at a proximal end of the boom 21.

The lower traveling body 11 serves as a base part for swingably supporting the upper slewing body 12. The upper slewing body 12 is swingably driven by an unillustrated drive source provided at the lower traveling body 11.

The crane 10 illustrated in FIG. 1 is a mobile crane. Thus, the lower traveling body 11 further includes a traveling device 14. The traveling device 14 is travelable on a traveling surface, for example, on a ground. Each of FIGS. 1 and 4 to 8 shows an example of the traveling device 14 of a crawler type.

In the crane 10, the lower traveling body 11 and the upper slewing body 12 serve as an example of the main body part directly or indirectly connected to the proximal end of the boom 21.

The cab 13 is a manipulation compartment. The boom 21 has a proximal end coupled to the upper slewing body 12. The boom 21 is tiltable about the proximal end coupled to the upper slewing body 12.

The jib 22 is rotatably coupled to a distal end of the boom 21. The strut 23 is provided at a coupling portion of the boom 21 and the jib 22. The gantry sheave 150 is provided at a distal end of the gantry 15. The jib point sheave 220 is provided at a distal end of the jib 22.

The first rope 31 is supported on the gantry sheave 150, and the first rope 31 has the opposite ends respectively connected to the boom 21 and the first winch 161. The first winch 161 supports the boom 21 via the first rope 31. The first rope 31 is referred to as, for example, a boom raising and lowering rope as well.

The first winch 161 changes an angle of the boom 21 by winding up the first rope 31 or unwinding out the first rope 31. The angle of the boom 21 means an angle of the boom 21 to the main body part, specifically, an elevation angle of the boom 21.

The second rope 32 is supported on the strut 23, and the second rope 32 has the opposite ends respectively connected to the jib 22 and the second winch 162. The second winch 162 supports the boom 21 via the second rope 32. The second rope 32 is referred to as, for example, a jib raising and lowering rope as well.

The second winch 162 changes an angle of the jib 22 to the boom 21 by winding up the second rope 32 or unwinding out the second rope 32.

The third rope 33 is supported on the jib point sheave 220. The hook 30 is suspended downward by the third rope 33 to support or hold a hoisted load. In other words, the third rope 33 is connected to the hook 30 and hangs down from the distal end of the jib 22. The third rope 33 is referred to as, for example, a lifting and lowering rope as well.

The third winch 163 changes a length of a hanging portion of the third rope 33 by winding up the third rope 33 or unwinding out the third rope 33. The hanging portion is a portion of the third rope 33 that hangs down from the distal end of the jib 22.

The hook 30 is lifted or lowered in accordance with a change in the length of the hanging portion. The hoisted load is hooked by the hook 30.

The counterweight 17 keeps a balance among the boom 21, the jib 22, and the hoisted load hooked by the hook 30.

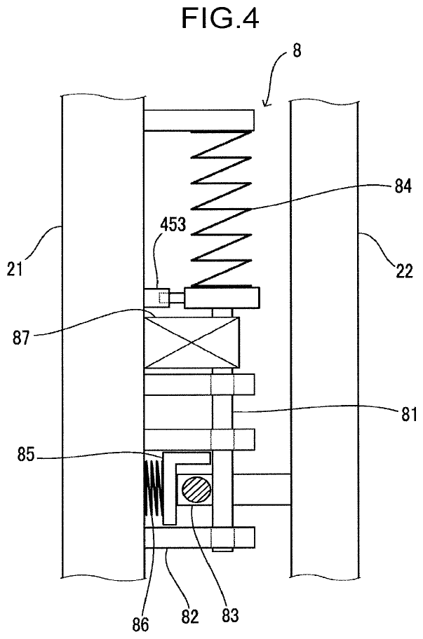

The latch device 8 is provided at the boom 21. The latch device 8 locks the jib 22 to the boom 21 when the jib 22 is in a state of extending along the boom 21 (see FIGS. 4, 5, and 8). In the following description, the state where the jib 22 is locked to the boom 21 by the latch device 8 is referred to as a locked state.

The latch device 8 is further configured to unlock the locked state in accordance with an unlocking instruction which is input. The unlocking instruction is transmitted from a controller 6 to be described later to the latch device 8. The jib 22 is locked to the boom 21 by the latch device 8 when the crane 10 finishes a work or on another occasion.

The latch device 8 is an example jib lock mechanism configured to lock the jib 22 to the boom 21 and unlock the locked state.

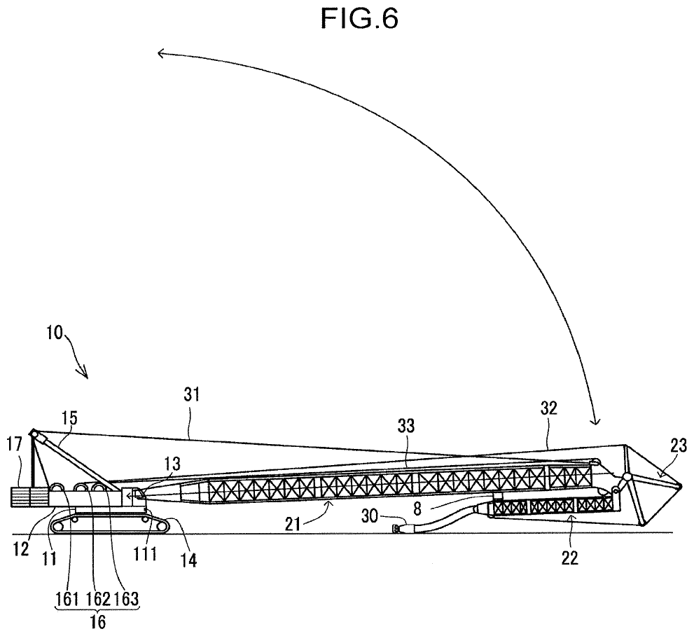

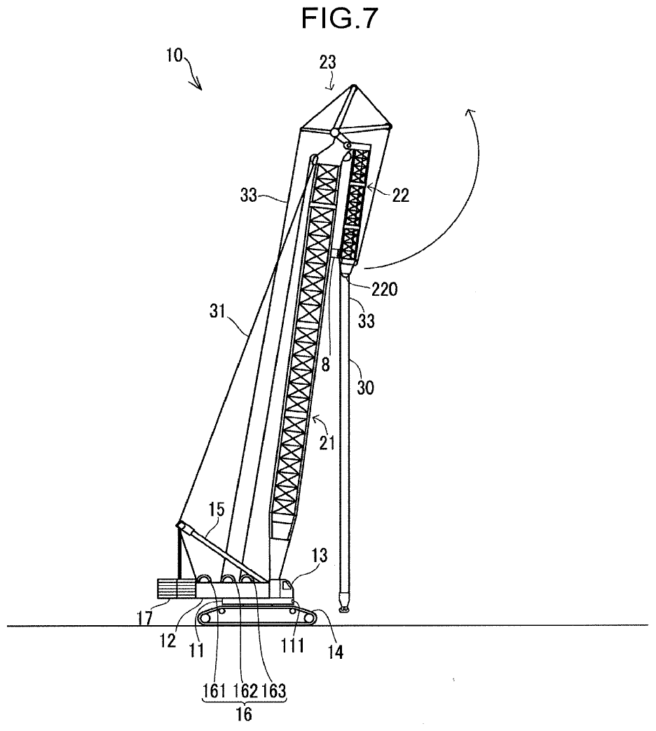

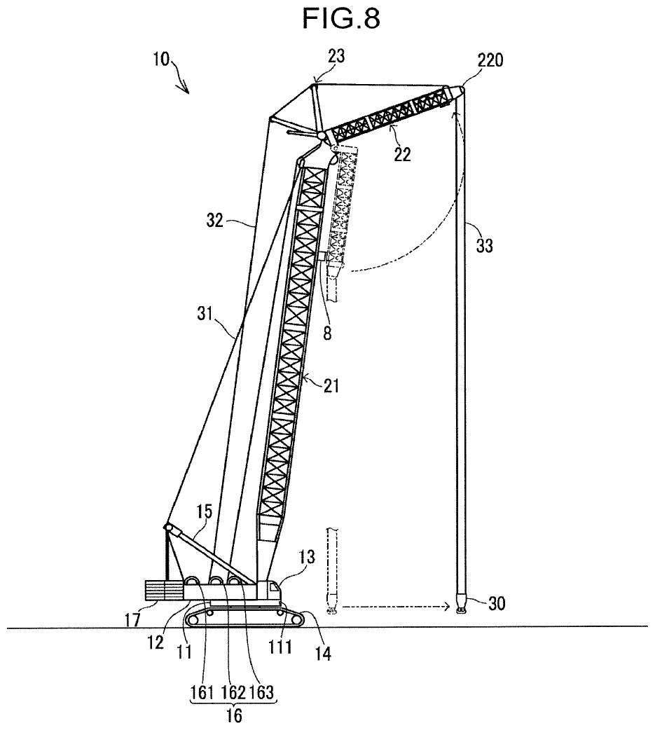

When the jib 22 is rotated downward by unwinding out of the second rope 32 to reach a position where the jib 22 extends along the boom 21 being in a raised state, the latch device 8 locks the jib 22 to the boom 21 (see FIGS. 7 and 8). After that, the boom 21 holding the jib 22 is lowered to lie along the ground by unwinding out of the first rope 31 (see FIG. 6).

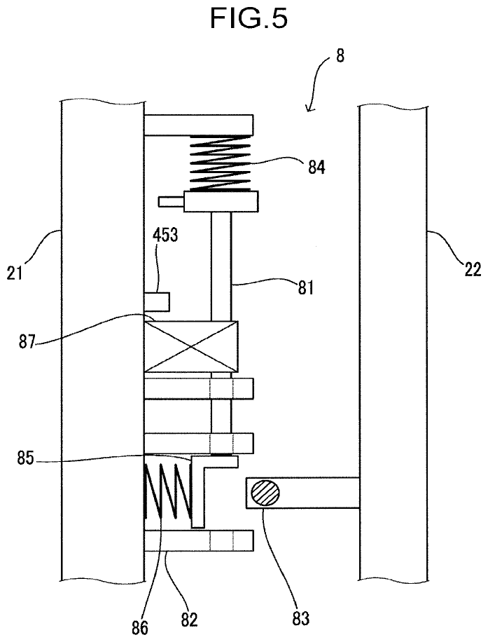

For instance, the latch device 8 includes an engaging member 81, a sliding support member 82, an engaged member 83, a first spring 84, a holding member 585, a second spring 86, and a driving device 87 (see FIGS. 4 and 5).

The engaged member 83 is fixedly attached to the jib 22. The sliding support member 82 is fixedly attached to the boom 21. The engaging member 81 is shiftably supported between a locking position and an unlocking position. The sliding support member 82 supports the engaging member 81 shiftably.

FIG. 4 shows a state where the engaging member 81 is in the locking position. FIG. 5 shows a state where the engaging member 81 is in the unlocking position.

The engaging member 81 engages with the engaged member 83 in the locking position. The engaging member 81 locks the jib 22 to the boom 21 by engaging with the engaged member 83 (see FIG. 4). In other words, a state where the engaging member 81 engages with the engaged member 83 results in making the locked state.

The first spring 84 urges the engaging member 81 toward the locking position. That is to say, when the jib 22 extends along the boom 21, the engaging member 81 engages with the engaged member 83 and the first spring 84 keeps the locked state.

The driving device 87 shifts the engaging member 81 from the locking position to the unlocking position against an urging force of the first spring 84 on receipt of an input of the unlocking instruction. In this manner, the latch device 8 changes the locked state to an unlocked state (see FIG. 5).

The driving device 87 avoids restricting the shifting of the engaging member 81 on no receipt of the input of the unlocking instruction into the driving device 87, so that the urging force of the first spring 84 is applied to the engaging member 81.

The holding member 85 is shiftably supported at the boom 21 between an engaging position and a disengaging position. The holding member 85 is shiftably supported by an unillustrated support part provided to the boom 21.

FIG. 5 shows a state where the holding member 85 is in the engaging position. FIG. 4 shows a state where the holding member 85 is in the disengaging position.

The holding member 85 engages with the engaging member 81 in the engaging position to hold the engaging member 81 in the unlocking position (see FIG. 5). The second spring 86 urges the holding member 85 toward the engaging position.

When the jib 22 rotates to the position where the jib extends along the boom 21, the engaged member 83 comes into contact with the holding member 85. The engaged member 83 comes into contact with the holding member 85 to shift the holding member 85 from the engaging position to the disengaging position against an urging force of the second spring 86 (see FIG. 4).

The holding member 85 shifts from the engaging position to the disengaging position to disengage the engaging member 81 held by the holding member 85 (see FIG. 4). Therefore, when the holding member 85 shifts to the disengaging position, the engaging member 81 shifts from the unlocking position to the locking position by the urging force of the first spring 84, and thus, the latch device 8 makes the locked state (see FIG. 4).

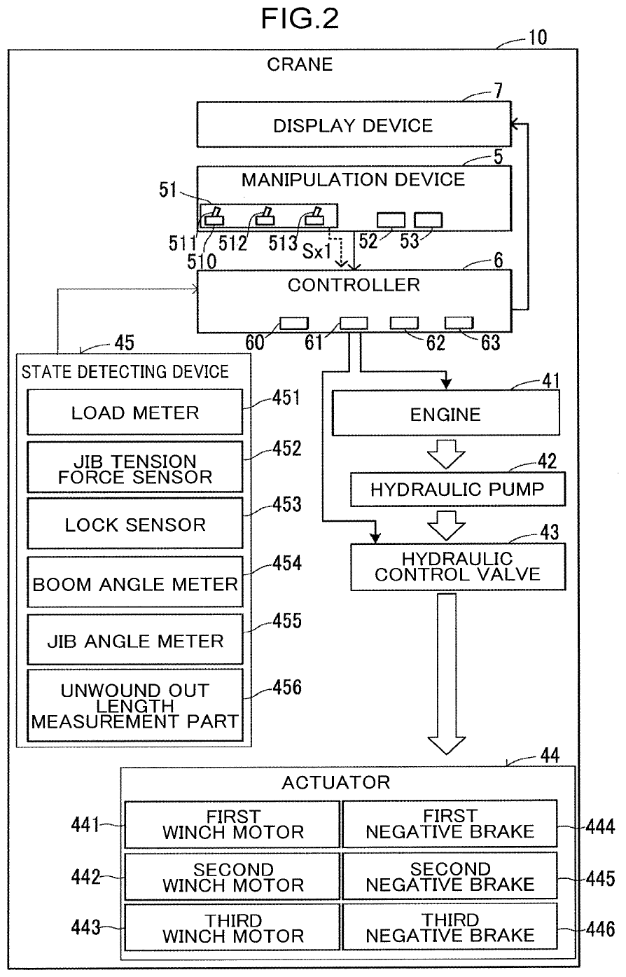

As shown in FIG. 2, the crane 10 includes: driving devices, such as an engine 41, a hydraulic pump 42, a hydraulic control valve 43, and an actuator 44; a manipulation device 5; the controller 6; and a display device 7. The actuator 44 is a hydraulic actuator. The controller 6 controls the crane 10.

Such devices as the manipulation device 5 and the display device 7 for a human interface are arranged in the cab 13. The crane 10 further includes a state detecting device 45 that detects states of various pieces of equipment included in the crane 10.

The manipulation device 5 receives a manipulation by an operator. The manipulation device 5 is an example of a manipulation part that receives a manipulation by a person. The display device 7 displays information.

For instance, the display device 7 includes a panel display device, such as a liquid crystal display unit. The manipulation device 5 includes a lever manipulation device 51, a manipulation button 52, and an input device 53.

The lever manipulation device 51 includes a plurality of manipulation levers each being shiftable. The lever manipulation device 51 further includes a shifting detector 510 that outputs a manipulation signal Sx1 representing a shifting state of each of the manipulation levers.

The manipulation signal Sx1 indicates a shifting direction from a home position of each of the manipulation levers and a shifting amount from the home position.

The manipulation levers include a boom manipulation lever 511, a jib manipulation lever 512, and a lifting and lowering manipulation lever 513.

The boom manipulation lever 511 receives a manipulation of instructing an operation of the first winch 161. The jib manipulation lever 512 receives a manipulation of instructing an operation of the second winch 162. The lifting and lowering manipulation lever 513 receives a manipulation of instructing an operation of the third winch 163.

The shifting directions of the manipulation levers 511, 512, 513 respectively represent instructions for winding up and unwinding out by the associated winches 161, 162, 163. The shifting amounts of the manipulation levers 511, 512, 513 respectively represent instructions of operation speeds of the associated winches 161, 162, 163.

The input device 53 receives an information input by the operator. For instance, the input device 53 includes a touch screen integrally formed with the display device 7. The input device 53 may receive an information input through a voice manipulation by the operator.

The state detecting device 45 includes a load meter 451, a jib tension force sensor 452, a lock sensor 453, a boom angle meter 454, and a jib angle meter 455. Various detection results from the state detecting device 45 are input into the controller 6.

The load meter 451 detects a weight of the hoisted load being hooked by the hook 30. The jib tension force sensor 452 detects a tension force applied to the second rope 32. The jib tension force sensor 452 is an example of a jib tension force detector.

For instance, the jib tension force sensor 452 is a load sensor, such as a load cell, attached to a connection member connecting the jib 22 and the second rope 32 to each other.

The lock sensor 453 is an example of a lock detector that detects the locked state. For instance, the lock sensor 453 includes a proximity switch or a limit switch for detecting the engaging member 81 of the latch device 8 when the engaging member 81 is in the locking position (see FIGS. 4 and 5).

The boom angle meter 454 is an example of a boom angle detector that detects an angle of the boom 21. The jib angle meter 455 is an example of a jib angle detector that detects an angle of the jib 22.

For instance, the boom angle meter 454 is considered as a tilt meter attached to the boom 21. In this case, the boom angle meter 454 detects an angle between a longitudinal direction of the boom 21 and a horizontal direction.

Similarly, the jib angle meter 455 is considered as a tilt meter attached to the jib 22. In this case, the jib angle meter 455 detects an angle between a longitudinal direction of the jib 22 and a horizontal direction.

The state detecting device 45 further includes an unwound out length measurement part 456. The unwound out length measurement part 456 measures an unwound out length of the third rope 33.

For instance, the unwound out length measurement part 456 measures an unwound out length of the third rope 33 by counting the rotational speed of a rotator that comes into contact with the third rope 33 to rotate together.

The engine 41 drives the hydraulic pump 42. The engine 41 is, for example, a diesel engine. The hydraulic control valve 43 supplies a compressed oil to the actuator 44 in accordance with a control signal output from the controller 6.

The actuator 44 includes a first winch motor 441, a second winch motor 442, and a third winch motor 443 each being a hydraulic motor. The actuator 44 further includes a first negative brake 444, a second negative brake 445, and a third negative brake 446.

The first winch motor 441 is a drive part for the first winch 161. The first negative brake 444 is a brake for the first winch 161. The controller 6 releases the first negative brake 444 and activates the first winch motor 441 to drive the first winch 161.

The second winch motor 442 is a drive part for the second winch 162. The second negative brake 445 is a brake for the second winch 162. The controller 6 releases the second negative brake 445 and activates the second winch motor 442 to drive the second winch 162.

The third winch motor 443 is a drive part for the third winch 163. The third negative brake 446 is a brake for the third winch 163. The controller 6 releases the third negative brake 446 and activates the third winch motor 443 to drive the third winch 163.

The actuator 44 further includes an unillustrated slewing motor that drives the upper slewing body 12 to rotate. The slewing motor is a hydraulic motor as well.

The controller 6 outputs a control signal to a control target, such as the hydraulic control valve 43, in response to a manipulation to the manipulation device 5 or each kind of detection result from the state detecting device 45. The controller 6 further starts the engine 41 in response to a start manipulation to the manipulation device 5. Moreover, the controller 6 controls the display device 7.

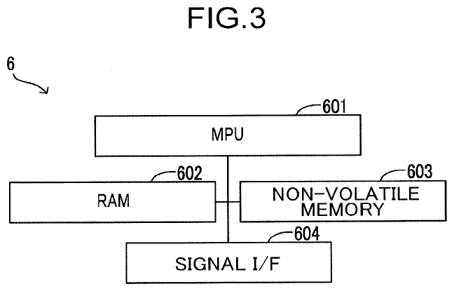

As shown in FIG. 3, the controller 6 includes a micro processing unit (MPU) 601, a random access memory (RAM) 602, a non-volatile memory 603, and a signal interface 604. Here, each of the RAM 602 and the non-volatile memory 603 is a computer readable storage device.

The MPU 601 is an example of a processor that executes each kind of data process and control by executing a program stored in the non-volatile memory 603 in advance.

The RAM 602 is a volatile memory that temporarily stores the program executed by the MPU 601, and data obtained or referred to by the MPU 601.

The non-volatile memory 603 stores, in advance, the program to be executed by the MPU 601 and the data to be referred to by the MPU 601. For instance, the non-volatile memory 603 is considered to include an electrically erasable programmable read only memory (EEPROM) or a flush memory.

The signal interface 604 converts a detection signal from the state detecting device 45 into digital data to be transmitted to the MPU 601. The signal interface 604 further converts a control instruction output by the MPU 601 into a control signal, such as an electric current signal or a voltage signal, to be output to a device which is a control target.

The crane 10 may include a boom tension force sensor (not shown) that detects a tension force applied to the first rope 31. In this case, the load meter 451 may include the boom tension force sensor, the jib tension force sensor 452, and the MPU 601 that executes load obtaining processing.

The MPU 601 obtains, in the load obtaining processing, a weight of the hoisted load on the basis of a detection value from each of the boom tension force sensor, the jib tension force sensor 452, the boom angle meter 454, and the jib angle meter 455.

The controller 6 further serves as a hanging length obtaining part 60 (see FIG. 2) in accordance with execution of a predetermined calculation program by the MPU 601.

The hanging length obtaining part 60 obtains a rope hanging length on the basis of a measurement result from the unwound out length measurement part 456 and a preset length of each of the boom 21 and the jib 22. The rope hanging length indicates a length of the hanging portion of the third rope 33. The hanging portion is a portion of the third rope 33 that hangs down from the distal end of the jib 22.

The hanging length obtaining part 60 may modify the rope hanging length on the basis of a detection angle from each of the boom angle meter 454 and the jib angle meter 455.

The unwound out length measurement part 456 and the hanging length obtaining part 60 serve as an example of a hanging length measurement part that measures the rope hanging length.

The hanging length measurement part may include a camera and an image processor that processes an image acquired by the camera. The camera is arranged at the upper slewing body 12 and photographs the hanging portion of the third rope 33.

The image processor extracts an image of the hanging portion of the third rope 33 from the image acquired by the camera. The image processor further obtains a distance to the hanging portion of the third rope 33 on the basis of the length of each of the boom 21 and the jib 22, and on the basis of a detection angle from each of the boom angle meter 454 and the jib angle meter 455.

The image processor obtains the rope hanging length on the basis of a length of the hanging portion of the third rope 33 in the image and a distance to the hanging portion of the third rope 33.

Coupling of the boom 21 to the upper slewing body 12 and coupling of the jib 22 to the boom 21 are performed on the worksite of the crane 10.

The boom 21 comes to a lowered state of extending along the ground at completion of the coupling of the boom 21 and the jib 22 to each other (see FIG. 6). When the boom 21 is in the lowered state, the latch device 8 makes the locked state.

The crane 10 comes to a predetermined reference state after the completion of the coupling of the boom 21 and the jib 22 to each other (see FIG. 8). In the reference state, the boom 21 substantially vertically stands, and the jib 22 is in a state of having swung out to a predetermined target angle.

By contrast, the boom 21 comes to the lowered state after a finish of a work by the crane 10 (see FIG. 6). The boom 21, the jib 22, and other component are disassembled after the boom 21 comes to the lowered state.

Meanwhile, the second rope 32 connected to the jib 22 may loosen while the boom 21 is rising in the locked state made by the latch device 8. The loosening of the second rope 32 may result in a failure of winding up of the second rope 32 by the second winch 162.

Besides, an excessive tension force may be applied to the second rope 32 connected to the jib 22 while the boom 21 is tilting downward in the locked state made by the latch device 8. The application of the excessive tension force to the second rope 32 may cause a trouble, such as a damage to the second rope 32.

The operator needs to manipulate the boom manipulation lever 511 and the jib manipulation lever 512 at the same time while confirming a state of each of the boom 21 and the jib 22 to avoid such loosening of the second rope 32 or such a damage to the second rope 32. The operator requires expertise for the manipulating.

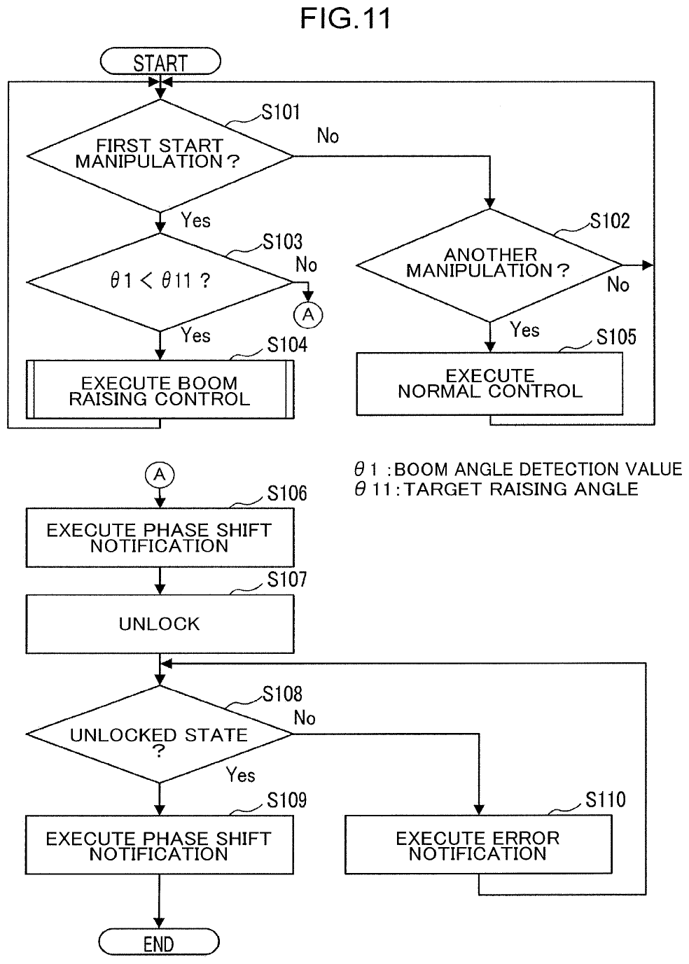

In the crane 10, the controller 6 executes a start control or raising control to be described later (see FIG. 11 to FIG. 14). In this way, only a simple manipulation to the manipulation device 5 enables the crane 10 to complete preparation for starting a work to be performed by the crane 10.

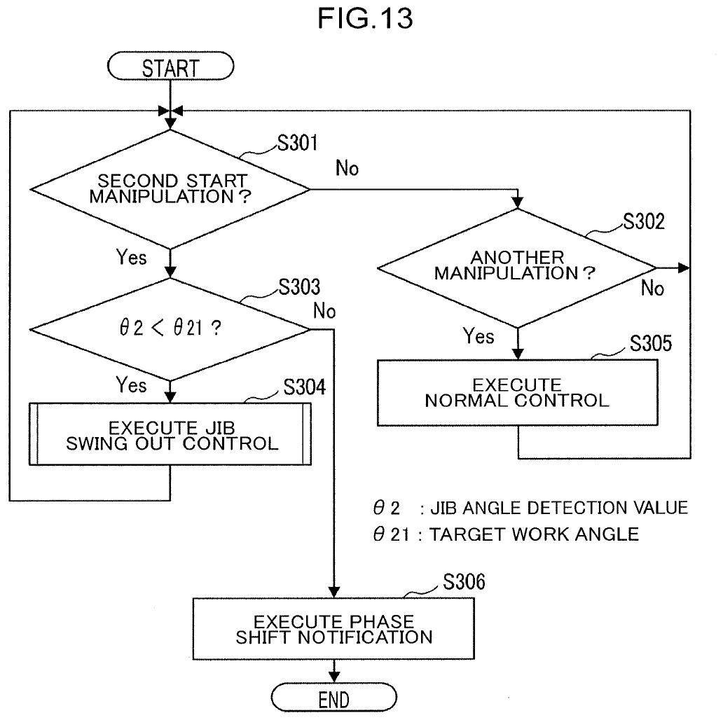

The start control represents an example in a crane control method. The crane control method is realized by the MPU 601 of the controller 6. As described below, the start control includes a first start control or first raising control (FIG. 11), and a second start control or second raising control (FIG. 13).

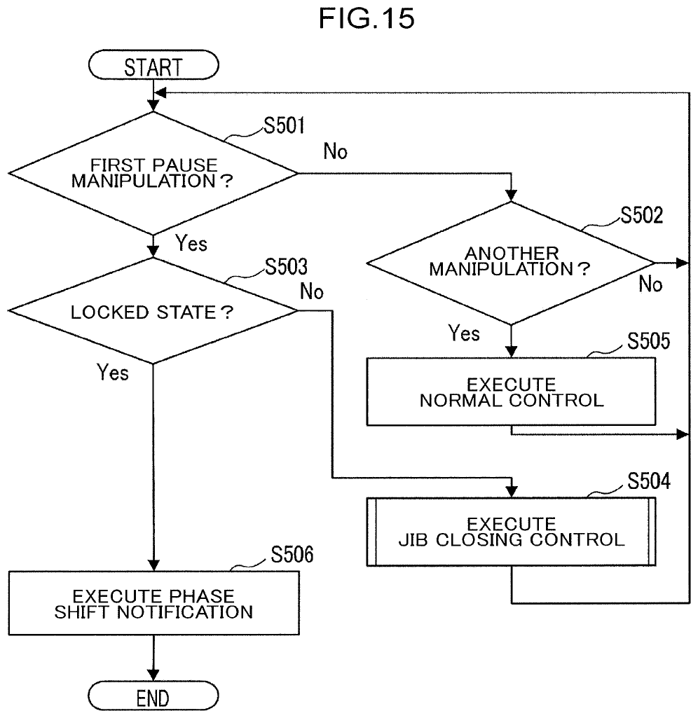

The controller 6 further executes a pause control or lowering control to be described later (FIG. 15 to FIG. 18). In this respect, only a simple manipulation to the manipulation device 5 enables the crane 10 to pause with the crane 10 being in the lowered state.

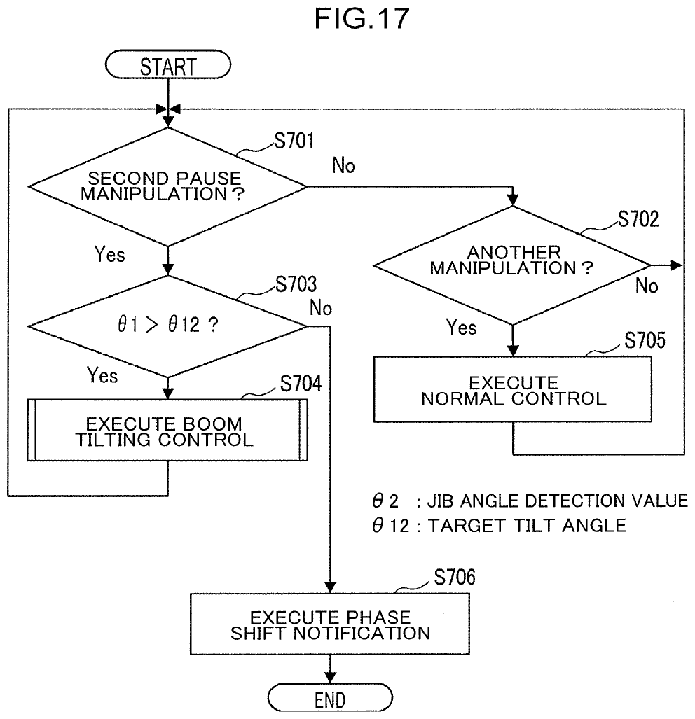

The pause control is an example in the crane control method. The crane control method is realized by the MPU 601 of the controller 6. As described below, the pause control includes a first pause control or first lowering control (FIG. 15), and a second pause control or second lowering control (FIG. 17).

The controller 6 selects one of a plurality of predetermined control modes to execute a control associated with the selected mode. The control modes include a normal mode, a start mode or raising mode, and a pause mode or lowering mode. The start mode is a mode to start a work by the crane 10 on a worksite. The pause mode is a mode to pause or suspend the work by the crane 10 on the worksite. Each of the start mode and the pause mode is an example of a predetermined special mode.

The controller 6 further serves as: a normal control part 61; a start control part 62 or raising control part; or a pause control part 63 or lowering control part (see FIG. 2), in accordance with execution of a predetermined control program by the MPU 601.

When the normal mode is selected, the normal control part 61 executes a predetermined process. When the start mode is selected, the start control part 62 executes a predetermined process. When the pause mode is selected, the pause control part 63 executes a predetermined process.

The controller 6 selects the normal mode when being activated. In this manner, the controller 6 is activated to drive the normal control part 61.

The normal control part 61 executes a normal control to the actuator 44 in response to a manipulation to the manipulation device 5.

Specifically, the normal control part 61 controls the first winch 161 in accordance with a shifting direction and a shifting amount of the boom manipulation lever 511 in response to a manipulation to the boom manipulation lever 511. The boom manipulation lever 511 receives a manipulation of instructing the first winch 161 to operate when the normal mode is set.

Similarly, the normal control part 61 controls the second winch 162 in accordance with a shifting direction and a shifting amount of the jib manipulation lever 512 in response to a manipulation to the jib manipulation lever 512. The jib manipulation lever 512 receives a manipulation of instructing the second winch 162 to operate when the normal mode is set.

Similarly, the normal control part 61 controls the third winch 163 in accordance with a shifting direction and a shifting amount of the lifting and lowering manipulation lever 513 in response to a manipulation to the lifting and lowering manipulation lever 513. The lifting and lowering manipulation lever 513 receives a manipulation of instructing the third winch 163 to operate when the normal mode is set.

The normal control part 61 selects the start mode in response to a predetermined first mode setting manipulation to the manipulation device 5. This makes the start control part 62 operate. The start control part 62 executes the first start control, and subsequently executes the second start control.

The start control part 62 selects the normal mode at a finish of the second start control. This makes the normal control part 61 operate.

The normal control part 61 selects the pause mode in response to a predetermined second mode setting manipulation to the manipulation device 5. This makes the pause control part 63 operate. The pause control part 63 executes the first pause control, and subsequently executes the second pause control.

Further, the pause control part 63 selects the normal mode at a finish of the second pause control. This makes the normal control part 61 operate.

For instance, the first mode setting manipulation and the second mode setting manipulation are intended for the manipulation button 52 or the input device 53. The second mode setting manipulation may be the same as the first mode setting manipulation. In this case, the controller 6 can determine whether a certain single manipulation is associated with either the start mode or the pause mode depending on a detection of the locked state that is made by the lock sensor 453. In other words, setting of a special mode like the start mode and the pause mode in the embodiment enables each of the boom 21 and the jib 22 to operate by a certain single manipulation lever, in place of a typical driven destination, i.e., a winch, for the boom manipulation lever 511 and the jib manipulation lever 512. This control is realized by, for example, each manipulation lever in the form of an electric lever.

The hanging length obtaining part 60 obtains the rope hanging length even in selection of any of the control modes.

### First Start Control

Next, an example sequence of the first start control will be described with reference to a flowchart shown in FIG. 11.

The start control part 62 executes the first start control under a condition that the start mode is set and the lock sensor 453 detects the locked state made by the latch device 8.

The start mode is set when the boom 21 is in the lowered state (see FIG. 6). The start control part 62 causes the display device 7 to display information indicating the setting of the start mode when the start mode is set. The information indicating the setting of the start mode includes one of or both an image and a character row.

In the following description, signs S101, S102, and subsequent signs express identification reference signs respectively for a plurality of steps in the first start control. The start control part 62 starts the steps from step S101 in the first start control.

In step S101 and step S102 to be described later, the start control part 62 checks a manipulation to the manipulation device 5. The start control part 62 executes step S103 in response to a predetermined first start manipulation or first raising manipulation to the manipulation device 5.

For instance, the first start manipulation is a manipulation to one (specific manipulation lever) of the boom manipulation lever 511 and the jib manipulation lever 512.

In the embodiment, the first start manipulation is a pulling manipulation to the boom manipulation lever 511. The pulling manipulation to the boom manipulation lever 511 represents a manipulation to the boom manipulation lever 511 for an instruction of winding up the first rope 31 when the normal mode is set. By contrast, the start control part 62 executes step S102 in no performance of the first start manipulation to the manipulation device 5.

In step S102, the start control part 62 checks whether the manipulation device 5 receives another manipulation except the first start manipulation. The start control part 62 executes step S105 in response to another manipulation except the first start manipulation to the manipulation device 5. By contrast, the start control part 62 leads the process to step S101 in no performance of both the first start manipulation and another manipulation to the manipulation device 5.

In step S103, the start control part 62 determines whether a boom angle detection value 01 reaches a predetermined target raising angle 011 or larger. The boom angle detection value 01 indicates a detection value or an angle of the boom from the boom angle meter 454. The boom angle detection value θ1 reaching the target raising angle θ11 or larger shows an example of the boom angle detection value θ1 falling within a predetermined target raising range. FIG. 7 shows a raised state of the boom 21. The raised state is a state of the boom 21 when the boom angle detection value θ1 reaches the target raising angle θ11 or larger. For example, the target raising angle θ11 is set to fall within a range from 85° to 89°.

The start control part 62 executes step S104 when the boom angle detection value θ1 is determined not to reach the target ranging angle θ11 or larger. By contrast, the start control part 62 executes step S106 when the boom angle detection value θ1 is determined to reach the target raising angle θ11 or larger.

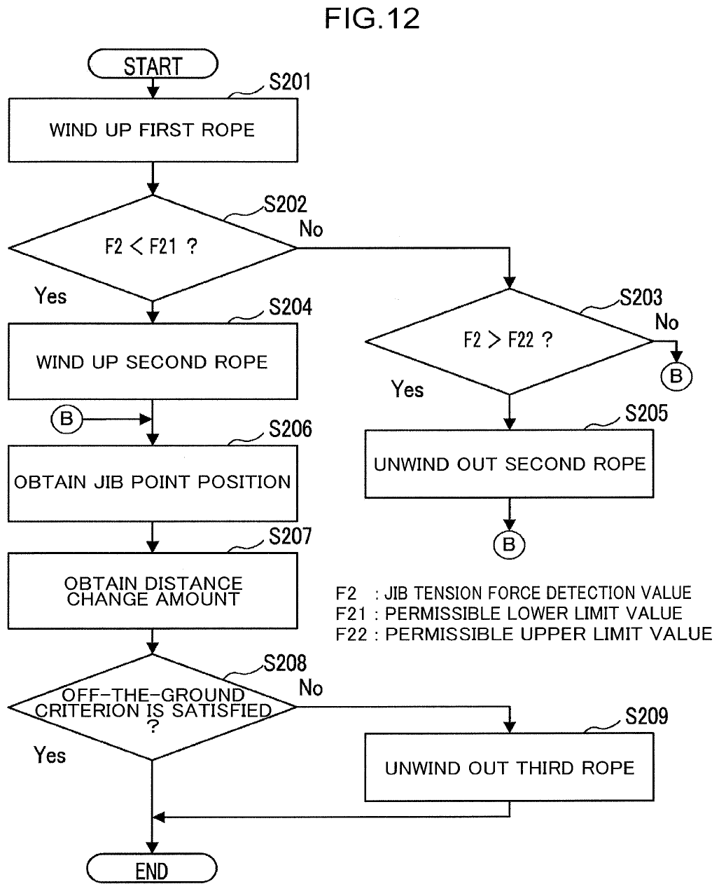

In step S104, the start control part 62 executes a boom raising control to be described later (see FIG. 12). The start control part 62 executes, in the boom raising control, a control of raising the boom 21 from the lowered state shown in FIG. 6 to the raised state shown in FIG. 7.

The start control part 62 leads the process to step S101 after the execution of the boom raising control. The start control part 62 executes the boom raising control (step S104) until the boom angle detection value θ1 reaches the target raising angle θ11 or larger in response to the first start manipulation to the manipulation device 5.

In step S105, the start control part 62 executes a normal control in response to another manipulation except the first start manipulation to the manipulation device 5. The normal control is to be executed in the normal mode by the normal control part 61.

For instance, the operator may suspend the first start manipulation in midway of raising the boom 21 from the lowered state to the raised state to give a manipulation for moving the hook 30 off the ground. The off-the-ground movement aims at lifting the hook 30 to a higher position than the ground. The manipulation for the off-the-ground movement is given to the lifting and lowering manipulation lever 513. Thus, in step S102, a manipulation to the lifting and lowering manipulation lever 513 may be detected. In this case, the start control part 62 controls an operation direction and an operation speed of the third winch 163 in accordance with a shifting direction and a shifting amount of the lifting and lowering manipulation lever 513 in step S105.

The start control part 62 leads the process to step S101 after the execution of step S105. For instance, the start control part 62 executes steps S101 to S105 in a predetermined cycle period.

The boom raising control is executed in response to the first start manipulation to the manipulation device 5 under the condition that the start mode is set and the lock sensor 453 detects the locked state.

The start control part 62 executes steps S101 to S105 including the boom raising control until the boom angle detection value θ1 reaches the target raising angle θ11 or larger. In other words, the start control part 62 finishes steps S101 to S105 including the boom raising control when the boom angle detection value θ1 reaches the target raising angle θ11 or larger.

In step S106, the start control part 62 executes a phase shift notification for notifying the operator of the reaching of the boom angle detection value θ1 to the target raising angle θ11 or larger. For instance, the phase shift notification includes a message display of causing the display device 7 to display the message.

The crane 10 may include a vibrator that vibrates a target manipulation lever for the first start manipulation. In this case, the phase shift notification may include causing the vibrator to vibrate the manipulation lever. Here, each of the display device 7 and the vibrator is an example of a notification part that executes a notification to a person who manipulates the manipulation device 5.

The start control part 62 executes step S107 after the execution of the phase shift notification in step S106. Step S107 is executed when the boom angle detection value θ1 reaches the target raising angle θ11 or larger.

In step S107, the start control part 62 causes the latch device 8 to unlock the locked state. Specifically, the start control part 62 outputs an unlocking instruction to the latch device 8. In this manner, the latch device 8 changes the locked state to the unlocked state. The start control part 62 further executes step S108. Here, step S107 exemplifies an unlocking control.

In step S108, the start control part 62 checks a detection from the lock sensor 453. The start control part 62 executes step S109 in no detection of the locked state by the lock sensor 453. By contrast, the start control part 62 executes step S110 when the lock sensor 453 detects the locked state.

In step S109, the start control part 62 executes a phase shift notification for notifying the operator of the unlocking of the locked state. The content of step S109 is similar to the content of step S106.

The start control part 62 finishes the first start control and further executes the second start control (see FIG. 13). The second start control will be described later.

In step S110, the start control part 62 executes an error notification. For instance, the start control part 62 causes the display device 7 to display a predetermined error message. Thereafter, the start control part 62 leads the process to step S108.

### Boom Raising Control

Subsequently, an example sequence of the boom raising control will be described with reference to a flowchart shown in FIG. 12.

In the following description, signs S201, S202, and subsequent signs express identification reference signs respectively for a plurality of steps in the boom raising control. The start control part 62 starts the steps from step S201 in the boom raising control.

In step S201, the start control part 62 causes the first winch 161 to wind up the first rope 31 in response to the first start manipulation. At this time, the start control part 62 causes the first winch 161 to operate at a speed corresponding to a shifting amount of a target manipulation lever for the first start manipulation in step S101.

In step S201, the start control part 62 may regulate an acceleration of the winding up of the first rope 31 by the first winch 161 within a first upper limit acceleration. In this case, the start control part 62 causes the first winch 161 to accelerate at the first upper limit acceleration when the acceleration in shifting of the target manipulation lever for the first start manipulation exceeds a predefined acceleration.

The start control part 62 further executes step S202.

In step S202 and step S203 to be described later, the start control part 62 checks a jib tension force detection value F2 being a detection value from the jib tension force sensor 452.

The start control part 62 executes step S204 when the jib tension force detection value F2 falls below a predetermined permissible lower limit value F21. By contrast, the start control part 62 executes step S203 when the jib tension force detection value F2 does not fall below the permissible lower limit value F21. In step S203, the start control part 62 checks whether the jib tension force detection value F2 exceeds a predetermined permissible upper limit value F22. A range from the permissible lower limit value F21 to the permissible upper limit value F22 indicates a permissible range of the tension force applied to the second rope 32.

The start control part 62 executes step S205 when the jib tension force detection value F2 exceeds the permissible upper limit value F22. By contrast, the start control part 62 executes step S206 when the jib tension force detection value F2 does not exceed the permissible upper limit value F22.

In step S204, the start control part 62 causes the second winch 162 to wind up the second rope 32. For instance, in step S204, the start control part 62 causes the second winch 162 to operate at a predetermined speed. In step S204, the start control part 62 may cause the second winch 162 to operate at a speed corresponding to a difference between the permissible lower limit value F21 and the jib tension force detection value F2. In step S204, the start control part 62 may cause the second winch 162 to operate for a time period associated with the difference between the permissible lower limit value F21 and the jib tension force detection value F2. The start control part 62 further executes step S206.

Execution of step S202 and step S204 keeps the second rope 32 from loosening in raising of the boom 21. Here, only the first start manipulation is required for the execution of step S202 and step S204. That is, step S202 and step S204 may be executed even without simultaneous execution of a plurality of manipulations. In other words, an operator is only required to manipulate a manipulation lever to cause the first winch 161 to wind up the first rope 31, and the start control part 62 automatically adjusts the tension force of the second rope 32. In particular, in the case where the second winch 162 that winds up or unwinds out the second rope 32 is supported by the upper slewing body 12 like the embodiment, the tension force of the second rope 32 is likely to change when the boom 21 is raised in a state where the jib 22 is locked to the boom 21. Even in this case, the start control part 62 adjusts the tension force of the second rope 32, so that the operator can concentrate on a raising manipulation for the boom 21.

In step S205, the start control part 62 causes the second winch 162 to unwind out the second rope 32. For instance, in step S205, the start control part 62 causes the second winch 162 to operate at a predetermined speed. In step S205, the start control part 62 may cause the second winch 162 to operate at a speed corresponding to a difference between the permissible lower limit value F21 and the jib tension force detection value F2.

In step S205, the start control part 62 may cause the second winch 162 to operate for a time period associated with the difference between the permissible upper limit value F22 and the jib tension force detection value F2. The start control part 62 further executes step S206. Execution of steps S202 to S205 keeps the second rope 32 from loosening and receiving an excessive tension force applied to the second rope 32 in execution of the boom raising control.

This consequently avoids a failure of winding up of the second rope 32 by the second winch 162, or a trouble, such as a damage to the second rope 32.

Here, step S205 is an exceptional step or special step that is not normally executed in the boom raising control, but is executed depending on the jib tension force detection value F2.

The following steps S206, S207, and S209 exemplify a hook movement prevention control of preventing the hook 30 from moving while being in contact with the ground. The start control part 62 executes the hook movement prevention control (see step S209) until an off-the-ground criterion is satisfied. By contrast, the start control part 62 keeps the third winch 163 from being controlled in the hook movement prevention control after the off-the-ground criterion is satisfied (see step S208).

Specifically, in step S206, the start control part 62 obtains, on the basis of the boom angle detection value θ1, a jib point position that changes by an operation of the first winch 161. The jib point position is at the distal end of the jib 22.

The start control part 62 obtains, on the basis of dimension information about each of the boom 21 and the jib 22 and the boom angle detection value θ1, a position at the distal end of the jib 22 to the main body part serving as a reference. The dimension information about each of the boom 21 and the jib 22 is known information.

The jib point position bears information about a horizontal position at the distal end of the jib 22 and information about a vertical position at the distal end of the jib 22. Therefore, processing of obtaining the jib point position includes obtaining a jib point height being at a position of the distal end of the jib 22 in an up-down direction. The start control part 62 further executes step S207.

In step S207, the start control part 62 obtains a distance change amount being a change amount in a distance between the jib point position and a hook position. The hook position is a preset position of the hook 30, that is, a position of the hook 30 in a state where the hook 30 is at a predetermined position on the ground.

For instance, the hook position is set with reference to the position of the distal end of the jib 22 in the lowered state of the boom 21. The start control part 62 further executes step S208.

In step S208, the start control part 62 determines whether a predetermined off-the-ground criterion is satisfied.

The off-the-ground criterion is a criterion that the third winch 163 winds up the third rope 33 to move the hook 30 off the ground. Generally, the off-the-ground movement of the hook 30 is executed in a state where the boom 21 is raised about 70° to 85° from the horizontal line.

For instance, the off-the-ground criterion is one of a first off-the-ground criterion and a second off-the-ground criterion. The off-the-ground criterion may be a logical conjunction or a logical disjunction of the first off-the-ground criterion and the second off-the-ground criterion.

The first off-the-ground criterion is a criterion that the lifting and lowering manipulation lever 513 receives a pulling manipulation in no performance of the first start manipulation under the condition that the start mode is set and the lock sensor 453 detects the locked state.

The pulling manipulation to the lifting and lowering manipulation lever 513 is an example manipulation of instructing the third winch 163 to wind up the third rope 33. The first off-the-ground criterion is satisfied when the pulling manipulation to the lifting and lowering manipulation lever 513 is detected in step S102 in FIG. 11.

The second off-the-ground criterion is a criterion that the manipulation button 52 or the input device 53 receives a predetermined confirmation manipulation. The operator gives the confirmation manipulation on his or her own will when the hook 30 is moved off the ground. The confirmation manipulation is given to input information about the off-the-ground movement into the start control part 62.

The start control part 62 executes step S209 when the off-the-ground criterion is determined not to be satisfied. By contrast, the start control part 62 finishes the hook movement prevention control when the off-the-ground criterion is determined to be satisfied. Thereafter, the start control part 62 leads the process to step S101 in FIG. 11.

In step S209, the start control part 62 causes the third winch 163 to unwind out the third rope 33 by a length corresponding to a distance change amount. Specifically, if the third rope 33 has a fixed length in raising of the boom 21 and the jib 22 integrally, the hook 30 may be dragged along with the movement of the distal end of the jib 22. The length of the third rope 33 is thus adjusted to prevent the dragging. The start control part 62 finishes the hook movement prevention control after the execution of step S209. Thereafter, the start control part 62 leads the process to step S101 in FIG. 11.

### Second Start Control

Next, an example sequence of the second start control will be described with reference to a flowchart shown in FIG. 13.

The start control part 62 executes the second start control after the lock sensor 453 ceases to detect the locked state made by the latch device 8 under the condition that the start mode is set (see steps S108 and S109 in FIG. 11).

In the following description, signs S301, S302, and subsequent signs express identification reference signs respectively for a plurality of steps in the second start control. The start control part 62 starts the steps from step S301 in the second start control.

In step S301 and step S302 to be described later, the start control part 62 checks a manipulation to the manipulation device 5. The start control part 62 executes step S303 in response to a predetermined second start manipulation or second raising manipulation to the manipulation device 5.

For instance, the second start manipulation is a manipulation to one of the boom manipulation lever 511 and the jib manipulation lever 512. The manipulation lever in the second start manipulation may be the same as the manipulation lever in the first start manipulation.

For instance, the second start manipulation may be a pulling manipulation to the boom manipulation lever 511. The pulling manipulation to the boom manipulation lever 511 represents a manipulation to the boom manipulation lever 511 for an instruction of winding up the first rope 31 when the normal mode is set. The second start manipulation may be a pulling manipulation to the jib manipulation lever 512. The pulling manipulation to the jib manipulation lever 512 represents a manipulation to the jib manipulation lever 512 for an instruction of winding up the second rope 32 when the normal mode is set. Specifically, in the start mode being a special mode, a certain same manipulation lever may be used in the first start manipulation and the second start manipulation to sequentially raise the boom 21 and the jib 22 (single lever manipulation), unlike a manipulation target in the normal mode.

By contrast, the start control part 62 executes step S302 in no performance of the second start manipulation to the manipulation device 5.

In step S302, the start control part 62 checks whether the manipulation device 5 receives another manipulation except the second start manipulation. The start control part 62 executes step S305 in response to another manipulation except the second start manipulation to the manipulation device 5.

By contrast, the start control part 62 leads the process to step S301 in no performance of both the second start manipulation and another manipulation to the manipulation device 5.

In step S303, the start control part 62 determines whether a jib angle detection value θ2 reaches a preset target work angle θ21 or larger (target work range). The jib angle detection value θ2 is a detection value from the jib angle meter 455. FIG. 8 shows an example reference state being a state of the crane 10 when the jib angle detection value θ2 reaches the target work angle θ21.

The start control part 62 executes step S304 when the jib angle detection value θ2 is determined not to reach the target work angle θ21 or larger. By contrast, the start control part 62 executes step S306 when the jib angle detection value θ2 is determined to reach the target work angle θ21 or larger.

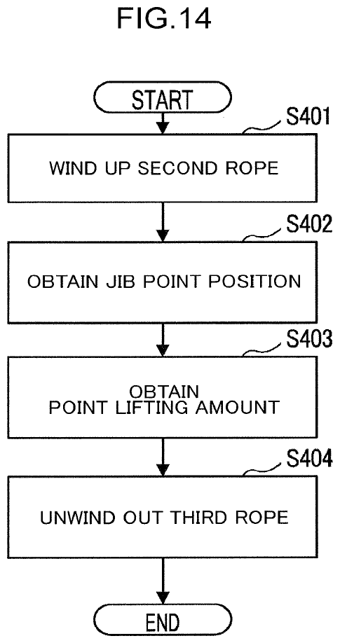

In step S304, the start control part 62 executes a jib swing out control to be described later (see FIG. 14). The start control part 62 executes, in the jib swing out control, a control of rotating the jib 22 from a closed state shown in FIG. 7 to an opened state shown in FIG. 8.

The start control part 62 executes the jib swing out control in response to the second start manipulation to the manipulation device 5 under the condition that the start mode is set (step S304). The start control part 62 executes the jib swing out control until the jib angle detection value θ2 reaches the target work angle θ21 or larger. The start control part 62 leads the process to step S301 after the execution of the jib swing out control.

In step S305, the start control part 62 executes a normal control in response to another manipulation except the second start manipulation to the manipulation device 5. Contents of step S302 and step S305 are respectively the same as those of step S102 and step S105 in FIG. 11.

The start control part 62 leads the process to step S301 after the execution of step S305. For instance, the start control part 62 executes steps S301 to S305 in a predetermined cycle period.

In step S306, the start control part 62 executes a phase shift notification for notifying the operator of the reaching of the jib angle detection value θ2 to the target work angle θ21 or larger. The content of step S306 is similar to the content of step S106. The start control part 62 finishes the second start control after the execution of step S306. Consequently, the start control is finished. In other words, the raising operation for the boom 21 and the jib 22 is finished.

### Jib Swing out Control

Subsequently, an example sequence of the jib swing out control will be described with reference to a flowchart shown in FIG. 14. The jib swing out control is executed when the locked state made by the latch device 8 is unlocked in the raised state of the boom 21.

In the following description, signs S401, S402, and subsequent signs express identification reference signs respectively for a plurality of steps in the jib swing out control. The start control part 62 starts the steps from step S401 in the jib swing out control.

In step S401, the start control part 62 causes the second winch 162 to wind up the second rope 32 in response to the second start manipulation. At this time, the start control part 62 causes the second winch 162 to operate at a speed corresponding to a shifting amount of a target manipulation lever for the second start manipulation in step S301 in FIG. 13.

In step S401, the start control part 62 may regulate an acceleration of the winding up of the second rope 32 by the second winch 162 within a second upper limit acceleration. In this case, the start control part 62 causes the second winch 162 to accelerate at the second upper limit acceleration when the acceleration in shifting of the target manipulation lever for the second start manipulation exceeds a predefined acceleration.

The start control part 62 further executes step S402. In step S402, the start control part 62 obtains, on the basis of the boom angle detection value θ1 and the jib angle detection value θ2, a jib point position that changes by an operation of the second winch 162.

The start control part 62 obtains the jib point position on the basis of dimension information about each of the boom 21 and the jib 22, the boom angle detection value θ1, and the jib angle detection value θ2. The dimension information about each of the boom 21 and the jib 22 is known information. As aforementioned, the jib point position bears information about the jib point height. The start control part 62 further executes step S403.

In step S403, the start control part 62 obtains a point lifting amount. The point lifting amount is a lifting amount of the distal end of the jib 22 that lifts owing to step S401. That is to say, the point lifting amount indicates a change amount in the jib point height.

The start control part 62 further executes step S404.

In step S404, the start control part 62 causes the third winch 163 to unwind out the third rope 33 by a length corresponding to the point lifting amount. The start control part 62 finishes the jib swing out control after the execution of step S404. Thereafter, the start control part 62 leads the process to step S301 in FIG. 13.

Steps S402 to S404 aim at keeping a distance from the ground to the hook 30 at a distance in execution of the off-the-ground movement (see FIG. 8). Execution of steps S402 to S404 allows the operator to rapidly perform a slinging operation around the ground when the crane 10 comes to the reference state.

The start control part 62 causes the notification part to execute a phase shift notification when a predetermined notification criterion is satisfied under the condition that the start mode is set (see steps S106 and S109 in FIG. 11, and step S306 in FIG. 13). The phase shift notification is an example of notification processing.

The notification criterion includes a first notification criterion associated with step S106, a second notification criterion associated with step S109, and a third notification criterion associated with step S306.

The first notification criterion is a criterion that the boom angle detection value θ1 reaches the target raising angle θ11 or larger (see step S103 in FIG. 11). The second notification criterion is a criterion that the lock sensor 453 cease to detect the locked state (step S108 in FIG. 11). The third notification criterion is a criterion that the jib angle detection value θ2 reaches the target work angle θ21 (see step S303 in FIG. 13).

Execution of the phase shift notification enables the operator to recognize a change in a control phase in the crane 10. Here, only a part of the first notification criterion, the second notification criterion, and the third notification criterion may be adopted as the normal criterion.

In the jib swing out control, the start control part 62 suspends an input of the unlocking instruction into the latch device 8 when a predetermined unlocking finish criterion is satisfied.

As aforementioned, the start control part 62 outputs the unlocking instruction to the latch device 8 in step S107 in FIG. 11.

For instance, the unlocking finish criterion includes a first unlocking criterion, a first unlocking criterion, or a second unlocking criterion.

The first unlocking criterion is a criterion that the jib angle detection value θ2 reaches a predetermined target transit angle. The target transit angle is an angle between an angle of the jib 22 in the closed state and the target work angle θ21. The second unlocking criterion is a criterion that the jib angle detection value θ2 changes by a predetermined target change angle since the unlocking instruction is output. The third unlocking criterion is a criterion that the second winch 162 winds up the second rope 32 for a predetermined time period after the unlocking instruction is output.

### First Pause Control

Next, an example sequence of the first pause control will be described with reference to a flowchart shown in FIG. 15.

The pause control part 63 executes the first pause control under a condition that the pause mode is set and a boom angle detection value θ1 reaches a target raising angle θ11 or larger.

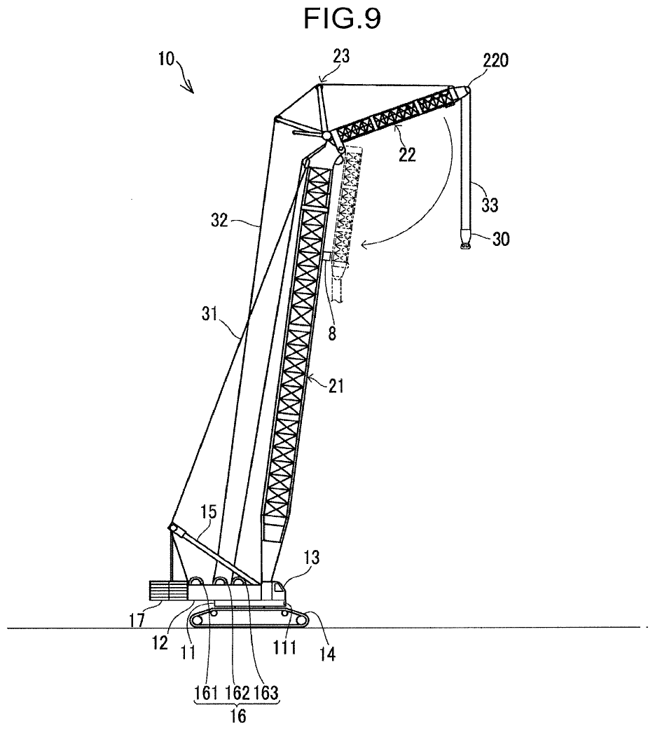

The pause mode is set in the raised state of each of the boom 21 and the jib 22 (see FIG. 9). The pause control part 63 causes the display device 7 to display information indicating the setting of the pause mode when the pause mode is set. The information indicating the setting of the pause mode includes one of or both an image and a character row.

In the following description, signs S501, S502, and subsequent signs express identification reference signs respectively for a plurality of steps in the second start control. The pause control part 63 starts the steps from step S501 in the second start control.

In step S501 and step S502 to be described later, the pause control part 63 checks a manipulation to the manipulation device 5. The pause control part 63 executes step S503 in response to a predetermined first pause manipulation or first lowering manipulation to the manipulation device 5.

For instance, the first pause manipulation is a manipulation to one of the boom manipulation lever 511 and the jib manipulation lever 512. In the embodiment, the first pause manipulation is a pushing manipulation to the jib manipulation lever 512. The pushing manipulation to the jib manipulation lever 512 represents a manipulation to the jib manipulation lever 512 for an instruction of unwinding out the second rope 32 when the normal mode is set.

By contrast, the pause control part 63 executes step S502 in no performance of the first pause manipulation to the manipulation device 5. In step S502, the pause control part 63 checks whether the manipulation device 5 receives another manipulation except the first pause manipulation. The pause control part 63 executes step S505 in response to another manipulation except the first pause manipulation to the manipulation device 5. By contrast, the pause control part 63 leads the process to step S501 in no performance of both the first pause manipulation and another manipulation to the manipulation device 5.

In step S503, the pause control part 63 checks a state from the lock sensor 453. The pause control part 63 executes step S504 in no detection of the locked state by the lock sensor 453. By contrast, the pause control part 63 executes step S506 when the lock sensor 453 detects the locked state.

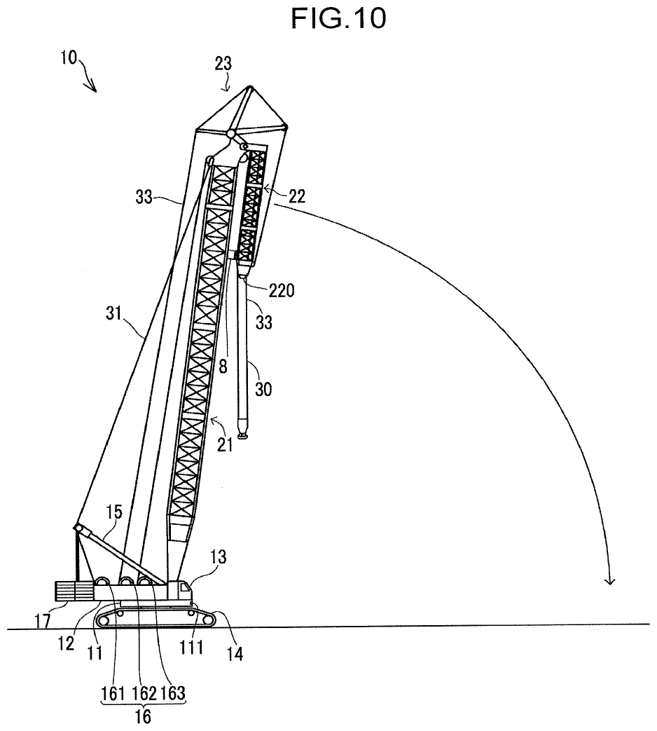

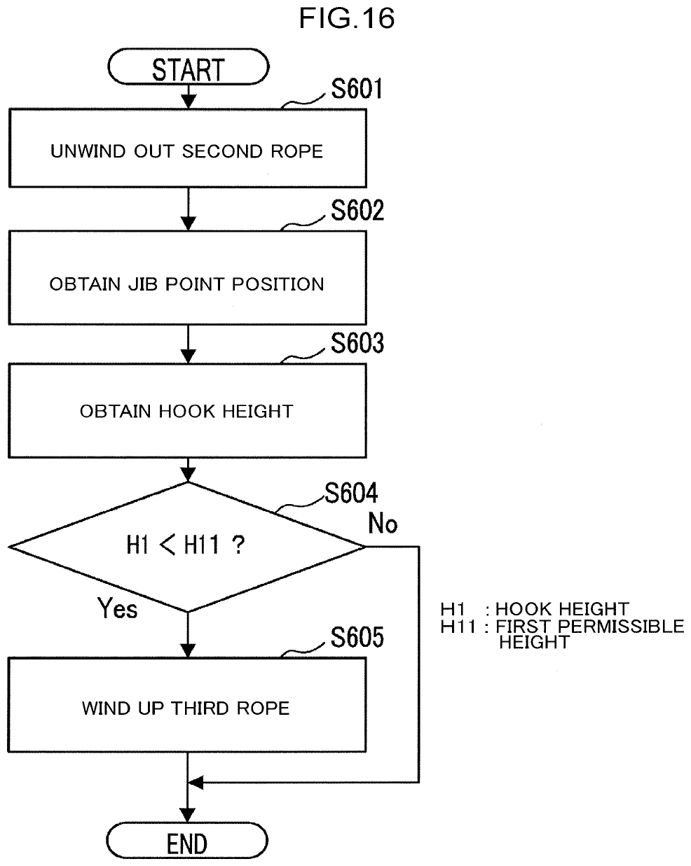

In step S504, the pause control part 63 executes a jib closing control to be described later (see FIG. 16). The pause control part 63 executes, in the jib closing control, a control of tilting the jib 22 downward from the opened state shown in FIG. 9 to the closed state shown in FIG. 10.

The pause control part 63 leads the process to step S501 after the execution of the jib closing control. The pause control part 63 executes the jib closing control until the locked state is detected in response to the first pause manipulation to the manipulation device 5 (step S504).

In step S505, the pause control part 63 executes the normal control in response to another manipulation except the first pause manipulation to the manipulation device 5. Contents of step S502 and step S505 are respectively the same as those of step S102 and step S105 in FIG. 11.

The pause control part 63 leads the process to step S501 after the execution of step S505. For instance, the pause control part 63 executes steps S501 to S505 in a predetermined cycle period.

The pause control part 63 executes the jib closing control in response to the first pause manipulation to the manipulation device 5 under a condition that the pause mode is set and a boom angle detection value θ1 reaches a target raising angle θ11 or larger. Besides, the jib closing control may be executed under a condition that the jib angle detection value θ2 reaches the target work angle θ21 or larger (target work range).

The pause control part 63 executes steps S501 to S505 including the jib closing control until the lock sensor 453 detects the locked state. In other words, the pause control part 63 finishes steps S501 to S505 including the jib closing control when the lock sensor 453 detects the locked state.

In step S506, the pause control part 63 executes a phase shift notification for notifying the operator of detection of the locked state. The content of step S506 is similar to the content of step S106 or step S108 in FIG. 11.

The pause control part 63 finishes the first pause control and further executes the second pause control (see FIG. 17). The second pause control will be described later.

### Jib Closing Control

Subsequently, an example sequence of the jib closing control will be described with reference to a flowchart shown in FIG. 16.

In the following description, signs S601, S602, and subsequent signs express identification reference signs respectively for a plurality of steps in the jib closing control. The pause control part 63 starts the steps from step S601 in the jib closing control.

In step S601, the pause control part 63 causes the second winch 162 to unwind out the second rope 32 in response to the first pause manipulation. At this time, the pause control part 63 causes the second winch 162 to operate at a speed corresponding to a shifting amount of a target manipulation lever for the first pause manipulation in step S501 in FIG. 15.

In step S601, the pause control part 63 may regulate an acceleration of the unwinding out of the second rope 32 by the second winch 162 within a third upper limit acceleration. In this case, the pause control part 63 causes the second winch 162 to accelerate at the third upper limit acceleration when the acceleration in shifting of the target manipulation lever for the first pause manipulation exceeds a predefined acceleration.

The pause control part 63 further executes step S602. In step S602, the pause control part 63 obtains, on the basis of the boom angle detection value θ1 and the jib angle detection value θ2, a jib point position that changes by an operation of the second winch 162.

The content of step S602 is the same as the content of step S402 in FIG. 14. The jib point position bears information about the jib point height. The start control part 62 further executes step S603.

In step S603, the pause control part 63 obtains a hook height H1 being a position of the hook 30 in the up-down direction. The pause control part 63 obtains the hook height H1 on the basis of the boom angle detection value θ1, the jib angle detection value θ2, and the rope hanging length. At this time, the pause control part 63 obtains the hook height H1 by using dimension information about each of the boom 21 and the jib 22. The dimension information about each of the boom 21 and the jib 22 is known information.

The pause control part 63 further executes step S604. In step S604, the pause control part 63 determines whether the hook height H1 falls below a preset first permissible height H11. The pause control part 63 executes step S605 when the hook height H1 is determined to fall below the first permissible height H11. By contrast, the pause control part 63 finishes the jib closing control when the hook height H1 is determined not to fall below the first permissible height H11. Thereafter, the pause control part 63 leads the process to step S501.

In step S605, the pause control part 63 causes the third winch 163 to wind up the third rope 33. For instance, in step S605, the pause control part 63 causes the third winch 163 to operate at a predetermined speed. In step S605, the pause control part 63 may cause the third winch 163 to operate at a speed corresponding to a difference between the first permissible height H11 and the hook height H1. In step S605, the pause control part 63 may cause the third winch 163 to operate for a time period associated with the difference between the first permissible height H11 and the hook height H1.

The pause control part 63 finishes the jib closing control after the execution of step S605. Thereafter, the pause control part 63 leads the process to step S501.

Execution of steps S602 to S605 keeps the hook 30 from landing or keeps the hook 30 from coming closer to the upper slewing body 12 due to the lowering of the jib 22 in the execution of the jib closing control.

### Second Pause Control

Next, an example sequence of the second pause control will be described with reference to a flowchart shown in FIG. 17.

The pause control part 63 executes the second pause control after the lock sensor 453 detects the locked state made by the latch device 8 under the condition that the pause mode is set.

In the following description, signs S701, S702, and subsequent signs express identification reference signs respectively for a plurality of steps in the second pause control. The pause control part 63 starts the steps from step S701 in the second pause control.

In step S701 and step S702 to be described later, the pause control part 63 checks a manipulation to the manipulation device 5. The pause control part 63 executes step S703 in response to a predetermined second pause manipulation or second lowering manipulation to the manipulation device 5.

For instance, the second pause manipulation is a manipulation to one of the boom manipulation lever 511 and the jib manipulation lever 512. The manipulation lever in the second pause manipulation may be the same as the manipulation lever in the first pause manipulation.

For instance, the second pause manipulation is a pushing manipulation to the boom manipulation lever 511. The pushing manipulation to the boom manipulation lever 511 represents a manipulation to the boom manipulation lever 511 for an instruction of unwinding out the first rope 31 when the normal mode is set.

The second pause manipulation may be a pushing manipulation to the jib manipulation lever 512. The pushing manipulation to the jib manipulation lever 512 represents a manipulation to the jib manipulation lever 512 for an instruction of unwinding out the second rope 32 when the normal mode is set. Specifically, in the pause mode being a special mode, a certain same manipulation lever may be used in the first pause manipulation and the second pause manipulation to sequentially lower the boom 21 and the jib 22 (single lever manipulation), unlike a manipulation target in the normal mode.

By contrast, the pause control part 63 executes step S702 in no performance of the second pause manipulation to the manipulation device 5.

In step S702, the pause control part 63 checks whether the manipulation device 5 receives another manipulation except the second pause manipulation. The pause control part 63 executes step S705 in response to another manipulation except the second pause manipulation to the manipulation device 5.

By contrast, the pause control part 63 leads the process to step S701 in no performance of both the second pause manipulation and another manipulation to the manipulation device 5.

In step S703, the pause control part 63 determines whether a boom angle detection value θ1 reaches a preset target tilting angle θ12 or smaller. The boom angle detection value θ1 reaching the target tilting angle θ12 or smaller shows an example of the boom angle detection value θ1 falling within a predetermined target tilting range. FIG. 6 shows a lowered state being a state of the crane 10 when the jib angle detection value θ2 reaches the target tilting angle θ12 or smaller.

The pause control part 63 executes step S704 when the jib angle detection value θ2 is determined not to reach the target tilting angle θ12 or smaller. By contrast, the pause control part 63 executes step S706 when the boom angle detection value θ1 is determined to reach the target tilting angle θ12 or smaller.

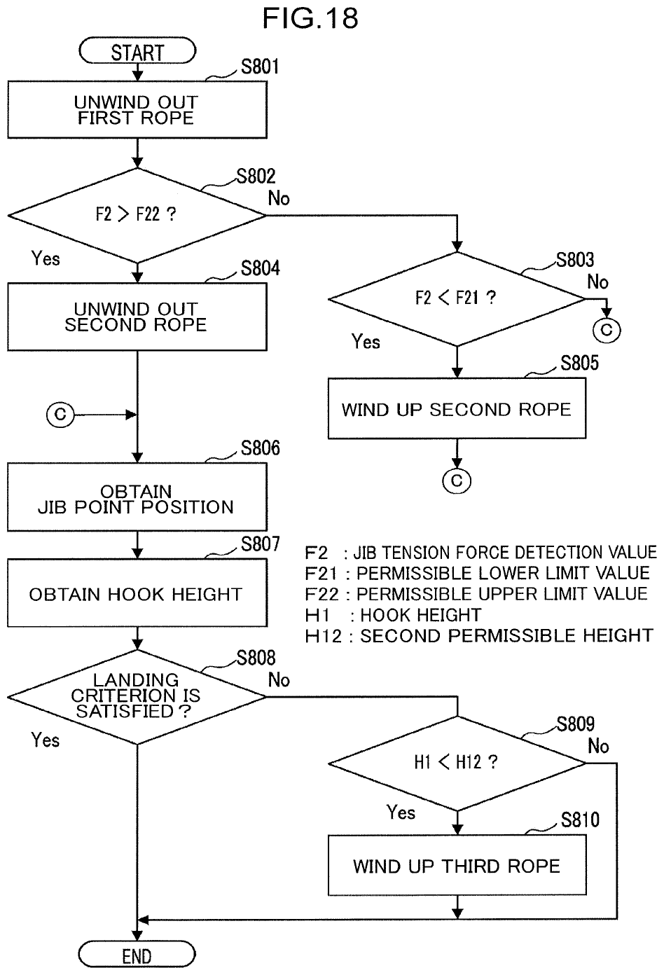

In step S704, the pause control part 63 executes a boom tilting control to be described later (see FIG. 18). The pause control part 63 executes, in the boom tilting control, a control of rotating the boom 21 from the raised state shown in FIG. 10 to the lowered state shown in FIG. 6.

The pause control part 63 leads the process to step S701 after the execution of the boom tilting control. The pause control part 63 executes the boom tilting control until the boom angle detection value θ1 reaches the target tilting angle θ12 or smaller in response to the second pause manipulation to the manipulation device 5 (step S704).

In step S705, the pause control part 63 executes the normal control in response to another manipulation except the second pause manipulation to the manipulation device 5. Contents of step S702 and step S705 are respectively the same as those of step S102 and step S105 in FIG. 11.

The pause control part 63 leads the process to step S701 after the execution of step S705. For instance, the pause control part 63 executes steps S701 to S705 in a predetermined cycle period.

In step S706, the pause control part 63 executes a phase shift notification for notifying the operator of the reaching of the boom angle detection value θ1 to the target tilting angle θ12 or smaller. The content of step S706 is similar to the content of step S106. The pause control part 63 finishes the second pause control after the execution of step S706. Consequently, the pause control is finished. In other words, the boom 21 and the jib 22 come to the lowered state together.

### Boom Tilting Control

Subsequently, an example sequence of the boom tilting control will be described with reference to a flowchart shown in FIG. 18.

In the following description, signs S801, S802, and subsequent signs express identification reference signs respectively for a plurality of steps in the boom tilting control. The pause control part 63 starts the steps from step S801 in the boom tilting control.

In step S801, the pause control part 63 causes the first winch 161 to unwind out the first rope 31 in response to the second pause manipulation. At this time, the pause control part 63 causes the first winch 161 to operate at a speed corresponding to a shifting amount of a target manipulation lever for the second pause manipulation.

In step S801, the pause control part 63 may regulate an acceleration of the unwinding out of the first rope 31 by the first winch 161 within a fourth upper limit acceleration. In this case, the pause control part 63 causes the first winch 161 to accelerate at the fourth upper limit acceleration when the acceleration in shifting of the target manipulation lever for the second pause manipulation in step S701 in FIG. 17 exceeds a predefined acceleration.

The pause control part 63 further executes step S802.

In step S802 and step S803 to be described later, the pause control part 63 checks a jib tension force detection value F2 being a detection value from the jib tension force sensor 452.

The pause control part 63 executes step S804 when the jib tension force detection value F2 exceeds a predetermined permissible upper limit value F22. By contrast, the pause control part 63 executes step S803 when the jib tension force detection value F2 does not exceed the permissible upper limit value F22.

In step S803, the pause control part 63 checks whether the jib tension force detection value F2 falls below a predetermined permissible lower limit value F21.

A range from the permissible lower limit value F21 to the permissible upper limit value F22 indicates a permissible range of the tension force applied to the second rope 32.

The pause control part 63 executes step S805 when the jib tension force detection value F2 falls below the permissible lower limit value F21. By contrast, the pause control part 63 executes step S806 when the jib tension force detection value F2 does not fall below the permissible lower limit value F21.

In step S804, the pause control part 63 causes the second winch 162 to unwind out the second rope 32. The content of step S804 is the same as the content of step S205 in FIG. 12.

Execution of step S802 and step S804 keeps the second rope 32 from receiving an excessive tension force applied thereto in lowering of the boom 21. Here, only the second pause manipulation is required for the execution of step S802 and step S804. That is, step S802 and step S804 may be executed even without simultaneous execution of a plurality of manipulations. In other words, an operator is only required to manipulate a manipulation lever to cause the first winch 161 to unwind out the first rope 31, and the start control part 62 automatically adjusts the tension force of the second rope 32. In particular, in the case where the second winch 162 that winds up or unwinds out the second rope 32 is supported by the upper slewing body 12 like the embodiment, the tension force of the second rope 32 is likely to change when the boom 21 is lowered in a state where the jib 22 is locked to the boom 21. Even in this case, the start control part 62 adjusts the tension force of the second rope 32, so that the operator can concentrate on a lowering manipulation for the boom 21.

In step S805, the pause control part 63 causes the second winch 162 to wind up the second rope 32. The content of step S805 is the same as the content of step S204 in FIG. 12. The pause control part 63 further executes step S806.

Execution of step S802 to step S805 keeps the second rope 32 from loosening and receiving an excessive tension force applied to the second rope 32 in execution of the boom tilting control. This consequently avoids a failure of winding up of the second rope 32 by the second winch 162, or a trouble, such as a damage to the second rope 32.

Here, step S805 is an exceptional step or special step that is not normally executed in the boom tilting control, but is executed depending on the jib tension force detection value F2.

In step S806, the pause control part 63 obtains, on the basis of the boom angle detection value θ1, a jib point position that changes by an operation of the first winch 161. The content of step S806 is the same as the content of step S206 in FIG. 12. As aforementioned, processing of obtaining the jib point position includes obtaining the jib point height. The pause control part 63 further executes step S807.

In step S807, the pause control part 63 obtains a hook height H1 on the basis of the boom angle detection value θ1, the jib angle detection value θ2, and the rope hanging length. The content of step S807 is the same as the content of step S603 in FIG. 16. The pause control part 63 further executes step S808.

In step S808, the pause control part 63 determines whether a predetermined landing criterion is satisfied.

The landing criterion includes a criterion that the third winch 163 unwinds out the third rope 33 to allow the hook 30 to land. For instance, the landing of the hook 30 is executed in a state where the boom 21 is tilted about 20° to 30° with respect to the horizontal line.

For instance, the landing criterion is one of a first landing criterion and a second landing criterion. The landing criterion may be a logical conjunction or a logical disjunction of the first landing criterion and the second landing criterion.

The first landing criterion is a criterion that the lifting and lowering manipulation lever 513 receives a pushing manipulation in no performance of the second pause manipulation under the condition that the pause mode is set and the lock sensor 453 detects the locked state. The pushing manipulation to the lifting and lowering manipulation lever 513 is an example manipulation of instructing the third winch 163 to unwind out the third rope 33. The first landing criterion is satisfied when the pushing manipulation to the lifting and lowering manipulation lever 513 is detected in step S702 in FIG. 17.

The second landing criterion is a criterion that the manipulation button 52 or the input device 53 receives a predetermined confirmation manipulation. The operator gives the confirmation manipulation on his or her own will when the hook 30 is landed. The confirmation manipulation is given to input information about the landing of the hook 30 into the start control part 62.

The pause control part 63 executes step S809 when the landing criterion is determined not to be satisfied. By contrast, the pause control part 63 finishes the boom tilting control when the landing criterion is determined to be satisfied. Thereafter, the pause control part 63 leads the process to step S701 in FIG. 17.

In step S809, the pause control part 63 determines whether the hook height H1 falls below a preset second permissible height H12. The pause control part 63 executes step S810 when the hook height H1 is determined to fall below the second permissible height H12.

By contrast, the pause control part 63 finishes the boom tilting control when the hook height Hl is determined not to fall below the second permissible height H12. Thereafter, the pause control part 63 leads the process to step S701.

In step S810, the pause control part 63 causes the third winch 163 to wind up the third rope 33.

For instance, in step S810, the pause control part 63 causes the third winch 163 to operate at a predetermined speed. In step S810, the pause control part 63 may cause the third winch 163 to operate at a speed corresponding to a difference between the second permissible height H12 and the hook height H1. In step S810, the pause control part 63 may cause the third winch 163 to operate for a time period associated with the difference between the second permissible height H12 and the hook height H1.

The pause control part 63 finishes the boom tilting control after the execution of step S810. Thereafter, the pause control part 63 leads the process to step S701.

Execution of step S806 to step S810 aims at preventing the hook 30 from landing against the will of the operator. Execution of step S809 and step S810 shows a control of the third winch 163 based on the hook height H1.

The pause control part 63 executes step S809 and step S810 until the landing criterion is satisfied. By contrast, the pause control part 63 avoids executing step S809 and step S810 after the landing criterion is satisfied.

The pause control part 63 causes the notification part to execute a phase shift notification when a predetermined notification criterion is satisfied under the condition that the pause mode is set (see step S506 in FIG. 15 and step S706 in FIG. 17).

The notification criterion includes a fourth notification criterion associated with step S506 and a fifth notification criterion associated with step S706. The fourth notification criterion is a criterion that the lock sensor 453 detects the locked state (see step S503 in FIG. 15). The fifth notification criterion is a criterion that the boom angle detection value θ1 reaches the target tilting angle θ12 or smaller (see step S703 in FIG. 17).

Execution of the phase shift notification enables the operator to recognize a change in a control phase in the crane 10. Here, only one of the fourth notification criterion and the fifth notification criterion may be adopted as the notification criterion.

### Modified Embodiments

### First Modification

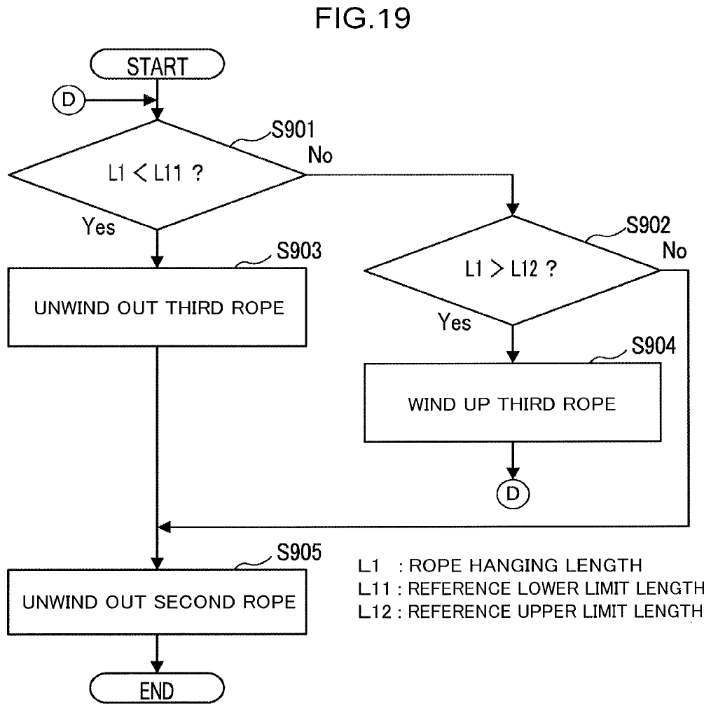

Next, a first modification for the crane 10 will be described with reference to FIG. 19.

In the modification, a pause control part 63 executes a jib closing control in a sequence shown in FIG. 19 in place of the jib closing control in the sequence shown in FIG. 16.

Hereinafter, an example sequence of the jib closing control in the modification will be described with reference to a flowchart shown in FIG. 19.

In the following description, signs S901, S902, and subsequent signs express identification reference signs respectively for a plurality of steps in the jib closing control. The pause control part 63 starts the steps from step S901 in the jib closing control.

In step S901, the pause control part 63 compares a rope hanging length L1 obtained by a hanging length obtaining part 60 with a preset reference lower limit length L11. The pause control part 63 executes step S903 when the rope hanging length L1 falls below the reference lower limit length L11. By contrast, the pause control part 63 executes step S902 when the rope hanging length L1 does not fall below the reference lower limit length L11.

In step S902, the pause control part 63 compares the rope hanging length L1 with a preset reference upper limit length L12.

The pause control part 63 executes step S904 when the rope hanging length L1 exceeds the reference upper limit length L12. By contrast, the pause control part 63 executes step S905 when the rope hanging length L1 falls within a range from the reference lower limit length L11 to the reference upper limit length L12.

The range from the reference lower limit length L11 to the reference upper limit length L12 represents a reference length range of the rope hanging length L1. The reference length range represents a range of the rope hanging length L1 suitable for the hook 30 to land in execution of the boom tilting control.

In step S903, the pause control part 63 causes the third winch 163 to unwind out the third rope 33. For instance, in step S903, the pause control part 63 causes the third winch 163 to operate at a predetermined speed. In step S903, the pause control part 63 may cause the third winch 163 to operate at a speed corresponding to a difference between the reference lower limit length L11 and the rope hanging length L1.

In step S903, the start control part 62 may cause the third winch 163 to operate for a time period associated with the difference between the reference lower limit length L11 and the rope hanging length L1. The pause control part 63 further executes step S905 subsequent to step S903.

In step S904, the pause control part 63 causes the third winch 163 to wind up the third rope 33. For instance, in step S904, the pause control part 63 causes the third winch 163 to operate at a predetermined speed. In step S904, the pause control part 63 may cause the third winch 163 to operate at a speed corresponding to a difference between the rope hanging length L1 and the reference upper limit length L12.

In step S904, the start control part 62 may cause the third winch 163 to operate for a time period associated with the difference between the rope hanging length L1 and the reference upper limit length L12. The pause control part 63 further executes step S905 subsequent to step S904.

In step S905, the pause control part 63 causes the second winch 162 to unwind out the second rope 32 in response to the first pause manipulation. At this time, the pause control part 63 causes the second winch 162 to operate at a speed corresponding to a shifting amount of a target manipulation lever for the first pause manipulation in step S501 in FIG. 15.

The pause control part 63 finishes the jib closing control after the execution of step S905. Thereafter, the pause control part 63 leads the process to step S501.

In the modification, the pause control part 63 executes step S903 or step S904 when the rope hanging length L1 is out of the reference length range. The pause control part 63 causes the third winch 163 to wind up the third rope 33 or unwind out the third rope 33 so that the rope hanging length L1 falls within the reference length range in step S903 or step S904.

Execution of step S901 to step S904 keeps the hook 30 from landing or keeps the hook 30 from coming closer to the upper slewing body 12 in the execution of the jib closing control.

Further, the execution of step S901 to step S904 keeps the hook 30 from landing against the will of the operator and keeps the hook 30 from moving while being in contact with the ground in the execution of the boom tilting control.

### Second Modification

Further, a second modification for the crane 10 will be described.

In the modification, a start control part 62 executes a manipulation restriction of inhibiting an operation of a drive part for a predetermined specific manipulation to a manipulation device 5 when a start mode is set.

Specifically, the start control part 62 executes the manipulation restriction in step S102 in the first start control and in step S302 in the second start control (see FIGS. 11 and 13).

That is to say, the start control part 62 skips step S105 when the specific manipulation to the manipulation device 5 is detected in step S102. Similarly, the start control part 62 skips step S305 when the specific manipulation to the manipulation device 5 is detected in step S302.

The start control part 62 may cause a display device 7 to display a predetermined error message when the manipulation device 5 receives the specific manipulation under a condition that the start mode is set.

For instance, the specific manipulation includes one of or both a slewing manipulation to a slewing lever and a traveling manipulation to a traveling pedal. The slewing lever and the traveling pedal constitute a part of the manipulation device 5.

The slewing lever receives the slewing manipulation of instructing an operation of a slewing motor to slew the upper slewing body 12. The traveling pedal receives the traveling manipulation of instructing an operation of a traveling device 14. The slewing motor is a part of the actuator 44.

When a normal mode is set, a normal control part 61 causes the slewing motor to operate in response to the slewing manipulation. Similarly, when the normal mode is set, the normal control part 61 causes the traveling device 14 to operate in response to the traveling manipulation.

Moreover, in the modification, a pause control part 63 may execute the manipulation restriction when a pause mode is set.

Specifically, the pause control part 63 executes the manipulation restriction in step S502 in the first pause control and in step S702 in the second pause control (see FIGS. 15 and 17).

Execution of the manipulation restriction keeps a drive part not to be operated from operating in the start mode or the pause mode. As a result, the crane 10 has higher safety in the setting of the start mode or the pause mode.

### Third modification

Moreover, a third modification for the crane 10 will be described.

This modification excludes step S108 and step S110 in the first start control.

In the modification, a start control part 62 executes an unlocking control in step S107 (see FIG. 11). Thereafter, the start control part 62 suspends an output of an unlocking instruction to a latch device 8 when an unlocking finish criterion is satisfied in a jib swing out control.

### Fourth Modification

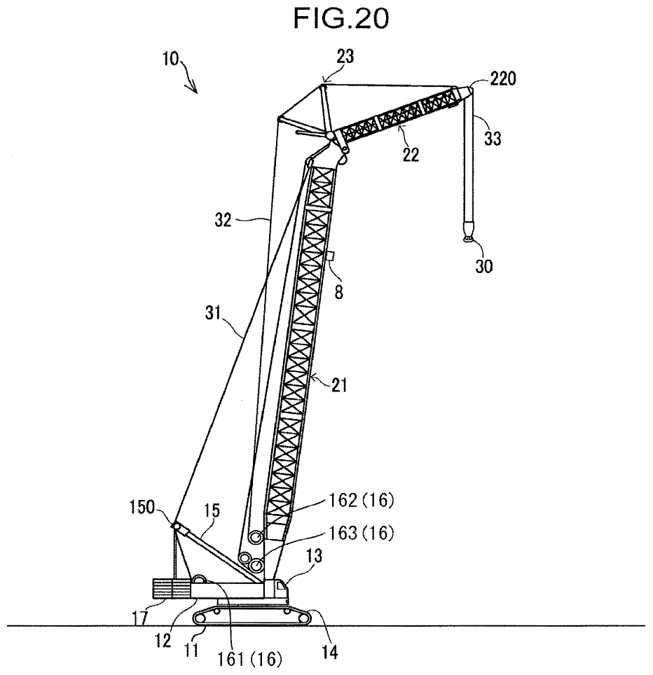

Next, a fourth modification for the crane 10 will be described. FIG. 20 is a configuration illustration of a crane 10 according to a modified embodiment of the present invention. FIG. 20 differs from FIG. 1 in that a second winch 162 and a third winch 163 are attached to a lower boom part of the boom 21. The crane control method according to the preceding embodiment is applicable to the crane 10 in FIG. 20. In particular, as shown in FIG. 20, even in a case where a jib raising and lowering winch 162 is attached to a boom, a tension force of a second rope 32 serving as a jib raising and lowering rope may fluctuate when the boom 21 and the jib 22 locked to each other integrally tilt. In this respect, a start control part 62 or a pause control part 63 controls the jib raising and lowering winch 162 to adjust the tension force of the second rope 32 to integrally tilt the boom 21 and the jib 22 in this modified embodiment as well as the preceding embodiment, so that an operator can concentrate on a raising manipulation or a lowering manipulation for the boom 21. It is noted here that the arrangement of each winch in the present invention is not limited to those shown in FIG. 1 and FIG. 20.

### Other Modifications

A tilting operation of the boom 21 or the jib 22 may be automatically performed in each of the start mode and the pause mode. In this case, each of the start manipulation and the pause manipulation may serve as an initial manipulation (switch) to start the tilting operation.

Although each process is executed under the condition that the lock sensor 453 detects the locked state made by the latch device 8 in the embodiment, the present invention is not limited thereto. Each control described above may be executed on the basis of an angle or a tilt angle of each of the boom 21 and the jib 22, or a relative angle to each other without using the lock sensor 453.

Although the pause control part 63 executes the second pause control after the lock sensor 453 detects the locked state made by the latch device 8 under the condition that the pause mode is set as shown in the flowchart shown in FIG. 17 in the embodiment, the present invention is not limited thereto.

For instance, when the lock sensor 453 is broken, the lock sensor 453 may detect a locked state despite incompletion of the locking by the latch device 8 in fact. In this case, the boom 21 and the jib 22 are not in an integrated arrangement. Under the circumstances, execution of the boom tilting control based on a result of the detection from the lock sensor 453 faces difficulty in safely lowering the boom 21 and the jib 22.

In this regard, the pause control part 63 may determine an unstable latching state despite detection of a locked state by the lock sensor 453 when, for example, an angle (acute angle) between the boom 21 and the jib 22 is 10° or larger, and may inhibit the boom tilting control. In this case, the display device 7 (FIG. 2) desirably displays an error message for a notification of the unstable latching state. The operator may desirably execute the jib closing control again on receipt of the error message to ensure the locking of the boom 21 and the jib 22 to each other.

The state of each of the boom 21 and the jib 22 may be confirmed on the basis of the angle therebetween in addition to a result of detection from the lock sensor 453 in execution of the jib swing out control as well. That is to say, unlocking by the latch device 8 is required to start the jib swing out control. However, the lock sensor 453 may detect such unlocking despite a locked state in fact. In this regard, the start control part 62 may determine a latching state despite detection of an unlocked state by the lock sensor 453 when, for example, an angle or acute angle between the boom 21 and the jib 22 is smaller than 5°, and may inhibit the jib swing out control.

Alternatively, the start control part 62 may inhibit the jib swing out control when a tension force of the second rope 32 exceeds a preset threshold. Specifically, starting the jib swing out control without unlocking the locked state may cause a rapid increase in the tension force of the second rope 32 serving as a jib raising and lowering rope due to the locked state of the boom 21 and the jib 22 in fact. In this regard, the start control part 62 may determine a failure in the unlocking in fact on the basis of the increase in the tension force and inhibit the jib swing out control.

The present invention provides a crane control method for controlling a crane including: a main body part; a boom tiltably coupled to the main body part; a first rope connected to the boom; a first winch that changes an angle of the boom to the main body part by winding up the first rope or unwinding out the first rope; a jib rotatably coupled to a distal end of the boom; a second rope connected to the jib; a second winch that changes an angle of the jib to the boom by winding up the second rope or unwinding out the second rope; a jib lock mechanism configured to lock the jib to the boom in a state where the jib extends along the boom and unlock a locked state of the jib to the boom; a lock detector configured to detect the locked state of the jib to the boom that is made by the jib lock mechanism; a hook for supporting a hoisted load; a third rope connected to the hook and hanging down from a distal end of the jib; a third winch that changes a length of a portion of the third rope that hangs down from the distal end of the jib by winding up the third rope or unwinding out the third rope; and a manipulation part that receives a manipulation by a person. The crane control method includes executing: a boom raising control until the angle of the boom reaches within a predetermined target raising range in response to a predetermined first raising manipulation to the manipulation part under a condition that a raising mode which is one of a plurality of predetermined control modes is set and the lock detector detects the locked state; an unlocking control of causing the jib lock mechanism to unlock the locked state after the angle of the boom reaches within the target raising range; and a jib swing out control until the angle of the jib reaches within a target work range in response to a predetermined second raising manipulation to the manipulation part under a condition that the raising mode is set after the execution of the unlocking control. The boom raising control includes: causing the first winch to wind up the first rope; and causing the second winch to wind up the second rope when a tension force of the second rope falls below a permissible range. The jib swing out control includes causing the second winch to wind up the second rope.

In the method, the boom raising control may further include executing a hook movement prevention control. The hook movement prevention control may further include: obtaining a jib point position on the basis of the angle of the boom, the jib point position being a position at the distal end of the jib and changing by an operation of the first winch; obtaining a distance change amount being a change amount in a distance between the jib point position and a preset position of the hook; and causing the third winch to unwind out the third rope by a length corresponding to the distance change amount.

In the method, in the boom raising control, the hook movement prevention control may be executed until a predetermined off-the-ground criterion is satisfied, and the third winch may be kept from being controlled in the hook movement prevention control after the off-the-ground criterion is satisfied.

In the method, the off-the-ground criterion may include a criterion that the manipulation part receives a manipulation of instructing the third winch to wind up the third rope in no performance of the first raising manipulation to the manipulation part under the condition that the raising mode is set and the lock detector detects the locked state.

In the method, the off-the-ground criterion may include a criterion that the manipulation part receives a predetermined confirmation manipulation.

In the method, the jib swing out control may further include: obtaining, on the basis of the angle of the boom and the angle of the jib, a jib point height being at a position of the distal end of the jib in an up-down direction; and causing the third winch to unwind out the third rope by a length corresponding to a change amount in the jib point height.

In the method, the manipulation part may include a plurality of manipulation levers which are shiftably supported, each of the first raising manipulation and the second raising manipulation may be a manipulation to one manipulation lever among the manipulation levers, the boom raising control may cause the first winch to wind up the first rope at a speed corresponding to a shifting amount of the manipulation lever, and the jib swing out control may further cause the second winch to wind up the second rope at a speed corresponding to the shifting amount of the manipulation lever.

In the method, the boom raising control may regulate an acceleration of the winding up of the first rope by the first winch within a first upper limit acceleration, and the jib swing out control may regulate an acceleration of the winding up of the second rope by the second winch within a second upper limit acceleration.

In the method, the second raising manipulation may be a manipulation to the same manipulation lever as the first raising manipulation.

The method may further include executing: a jib closing control until the lock detector detects the locked state in response to a predetermined first lowering manipulation to the manipulation part under a condition that a lowering mode which is one of the control modes is set and the angle of the boom is within the target raising range; and a boom tilting control until the angle of the boom reaches within a predetermined target tilting range in response to a predetermined second lowering manipulation to the manipulation part under a condition that the lowering mode is set after the lock detector detects the locked state. The jib closing control may include causing the second winch to unwind out the second rope. The boom tilting control may include: causing the first winch to unwind out the first rope; and causing the second winch to unwind out the second rope when the tension force of the second rope exceeds the permissible range.

Besides, the present invention provides a crane control method for controlling a crane including: a main body part; a boom tiltably coupled to the main body part; a first rope connected to the boom; a first winch that changes an angle of the boom to the main body part by winding up the first rope or unwinding out the first rope; a jib rotatably coupled to a distal end of the boom; a second rope connected to the jib; a second winch that changes an angle of the jib to the boom by winding up the second rope or unwinding out the second rope; a jib lock mechanism configured to lock the jib to the boom in a state where the jib extends along the boom and unlock a locked state of the jib to the boom; a lock detector configured to detect the locked state of the jib to the boom that is made by the jib lock mechanism; a hook for supporting a hoisted load; a third rope connected to the hook and hanging down from a distal end of the jib; a third winch that changes a length of a portion of the third rope that hangs down from the distal end of the jib by winding up the third rope or unwinding out the third rope; and a manipulation part that receives a manipulation by a person. The crane control method includes executing: a jib closing control until the lock detector detects the locked state in response to a predetermined first lowering manipulation to the manipulation part under a condition that a lowering mode which is one of a plurality of predetermined control modes is set and the angle of the boom is within a predetermined target raising range; and a boom tilting control until the angle of the boom reaches within a predetermined target tilting range in response to a predetermined second lowering manipulation to the manipulation part under a condition that the lowering mode is set after the lock detector detects the locked state. The jib closing control includes causing the second winch to unwind out the second rope. The boom tilting control includes: causing the first winch to unwind out the first rope; and causing the second winch to unwind out the second rope when the tension force of the second rope exceeds a permissible range.

1. A crane control method for controlling a crane including:
a main body part;
a boom tiltably coupled to the main body part;
a first rope connected to the boom;
a first winch that changes an angle of the boom to the main body part by winding up the first rope or unwinding out the first rope;
a jib rotatably coupled to a distal end of the boom;
a second rope connected to the jib;
a second winch that changes an angle of the jib to the boom by winding up the second rope or unwinding out the second rope;
a jib lock mechanism configured to lock the jib to the boom in a state where the jib extends along the boom and unlock a locked state of the jib to the boom;
a lock detector configured to detect the locked state of the jib to the boom that is made by the jib lock mechanism;
a hook for supporting a hoisted load;
a third rope connected to the hook and hanging down from a distal end of the jib;
a third winch that changes a length of a portion of the third rope that hangs down from the distal end of the jib by winding up the third rope or unwinding out the third rope; and
a manipulation part that receives a manipulation by a person, the crane control method comprising executing:
a boom raising control until the angle of the boom reaches within a predetermined target raising range in response to a predetermined first raising manipulation to the manipulation part under a condition that a raising mode which is one of a plurality of predetermined control modes is set and the lock detector detects the locked state;
an unlocking control of causing the jib lock mechanism to unlock the locked state after the angle of the boom reaches within the target raising range; and
a jib swing out control until the angle of the jib reaches within a target work range in response to a predetermined second raising manipulation to the manipulation part under a condition that the raising mode is set after the execution of the unlocking control, wherein
the boom raising control includes:
causing the first winch to wind up the first rope; and
causing the second winch to wind up the second rope when a tension force of the second rope falls below a permissible range, and
the jib swing out control includes causing the second winch to wind up the second rope.

2. The crane control method according to claim 1, wherein the boom raising control further includes executing a hook movement prevention control,
the hook movement prevention control including:
obtaining a jib point position on the basis of the angle of the boom, the jib point position being a position at the distal end of the jib and changing by an operation of the first winch;
obtaining a distance change amount being a change amount in a distance between the jib point position and a preset position of the hook; and
causing the third winch to unwind out the third rope by a length corresponding to the distance change amount.

3. The crane control method according to claim 2, wherein,
in the boom raising control, the hook movement prevention control is executed until a predetermined off-the-ground criterion is satisfied, and the third winch is kept from being controlled in the hook movement prevention control after the off-the-ground criterion is satisfied.

4. The crane control method according to claim 3, wherein the off-the-ground criterion includes a criterion that the manipulation part receives a manipulation of instructing the third winch to wind up the third rope in no performance of the first raising manipulation to the manipulation part under the condition that the raising mode is set and the lock detector detects the locked state.

5. The crane control method according to claim 3, wherein the off-the-ground criterion includes a criterion that the manipulation part receives a predetermined confirmation manipulation.

6. The crane control method according to claim 1, wherein the jib swing out control further includes:
obtaining, on the basis of the angle of the boom and the angle of the jib, a jib point height being at a position of the distal end of the jib in an up-down direction; and
causing the third winch to unwind out the third rope by a length corresponding to a change amount in the jib point height.

7. The crane control method according to claim 1, wherein the manipulation part includes a plurality of manipulation levers which are shiftably supported,
each of the first raising manipulation and the second raising manipulation is a manipulation to one manipulation lever among the manipulation levers,
the boom raising control causes the first winch to wind up the first rope at a speed corresponding to a shifting amount of the manipulation lever, and
the jib swing out control further causes the second winch to wind up the second rope at a speed corresponding to the shifting amount of the manipulation lever.

8. The crane control method according to claim 7, wherein the boom raising control regulates an acceleration of the winding up of the first rope by the first winch within a first upper limit acceleration, and
the jib swing out control regulates an acceleration of the winding up of the second rope by the second winch within a second upper limit acceleration.

9. The crane control method according to claim 7, wherein the second raising manipulation is a manipulation to the same manipulation lever as the first raising manipulation.

10. The crane control method according to claim 1, further comprising executing:
a jib closing control until the lock detector detects the locked state in response to a predetermined first lowering manipulation to the manipulation part under a condition that a lowering mode which is one of the control modes is set and the angle of the boom is within the target raising range; and
a boom tilting control until the angle of the boom reaches within a predetermined target tilting range in response to a predetermined second lowering manipulation to the manipulation part under a condition that the lowering mode is set after the lock detector detects the locked state, wherein
the jib closing control includes causing the second winch to unwind out the second rope, and
the boom tilting control includes:
causing the first winch to unwind out the first rope; and
causing the second winch to unwind out the second rope when the tension force of the second rope exceeds the permissible range.

11. A crane control method for controlling a crane including:
a main body part;
a boom tiltably coupled to the main body part;
a first rope connected to the boom;
a first winch that changes an angle of the boom to the main body part by winding up the first rope or unwinding out the first rope;
a jib rotatably coupled to a distal end of the boom;
a second rope connected to the jib;
a second winch that changes an angle of the jib to the boom by winding up the second rope or unwinding out the second rope;
a jib lock mechanism configured to lock the jib to the boom in a state where the jib extends along the boom and unlock a locked state of the jib to the boom;
a lock detector configured to detect the locked state of the jib to the boom that is made by the jib lock mechanism;
a hook for supporting a hoisted load;
a third rope connected to the hook and hanging down from a distal end of the jib;
a third winch that changes a length of a portion of the third rope that hangs down from the distal end of the jib by winding up the third rope or unwinding out the third rope; and
a manipulation part that receives a manipulation by a person, the crane control method comprising executing:
a jib closing control until the lock detector detects the locked state in response to a predetermined first lowering manipulation to the manipulation part under a condition that a lowering mode which is one of a plurality of predetermined control modes is set and the angle of the boom is within a predetermined target raising range; and
a boom tilting control until the angle of the boom reaches within a predetermined target tilting range in response to a predetermined second lowering manipulation to the manipulation part under a condition that the lowering mode is set after the lock detector detects the locked state, wherein
the jib closing control includes causing the second winch to unwind out the second rope, and
the boom tilting control includes:
causing the first winch to unwind out the first rope; and
causing the second winch to unwind out the second rope when the tension force of the second rope exceeds a permissible range.

12. A crane comprising:
a main body part;
a boom tiltably coupled to the main body part;
a first rope connected to the boom;
a first winch that changes an angle of the boom to the main body part by winding up the first rope or unwinding out the first rope;
a boom angle detector that detects the angle of the boom;
a jib rotatably coupled to a distal end of the boom;
a second rope connected to the jib;
a second winch that changes an angle of the jib to the boom by winding up the second rope or unwinding out the second rope;
a jib angle detector that detects the angle of the jib;
a jib tension force detector that detects a tension force applied to the second rope;
a jib lock mechanism configured to lock the jib to the boom in a state where the jib extends along the boom and unlock a locked state of the jib to the boom;
a lock detector configured to detect the locked state of the jib to the boom that is made by the jib lock mechanism;
a hook for supporting a hoisted load;
a third rope connected to the hook and hanging down from a distal end of the jib;
a third winch that changes a length of a portion of the third rope that hangs down from the distal end of the jib by winding up the third rope or unwinding out the third rope;
a manipulation part that receives a manipulation by a person; and
a controller that executes the crane control method according to claim 1.

13. A crane comprising:
a main body part;
a boom tiltably coupled to the main body part;
a first rope connected to the boom;
a first winch that changes an angle of the boom to the main body part by winding up the first rope or unwinding out the first rope;
a boom angle detector that detects the angle of the boom;
a jib rotatably coupled to a distal end of the boom;
a second rope connected to the jib;
a second winch that changes an angle of the jib to the boom by winding up the second rope or unwinding out the second rope;
a jib angle detector that detects the angle of the jib;
a jib tension force detector that detects a tension force applied to the second rope;
a jib lock mechanism configured to lock the jib to the boom in a state where the jib extends along the boom and unlock a locked state of the jib to the boom;
a lock detector configured to detect the locked state of the jib to the boom that is made by the jib lock mechanism;
a hook for supporting a hoisted load;
a third rope connected to the hook and hanging down from a distal end of the jib;
a third winch that changes a length of a portion of the third rope that hangs down from the distal end of the jib by winding up the third rope or unwinding out the third rope;
a manipulation part that receives a manipulation by a person; and
a controller that executes the crane control method according to claim 11.
